(19) United States
(12) Patent Application Publication
(10) Pub. No.: US 2016/0027110 A1
(43) Pub. Date: Jan. 28, 2016

(54) DYNAMIC TICK TRADING PLATFORM

(71) Applicants: Michael Blum, Western Springs, IL (US); Jon Ross, Chicago, IL (US); Daniel Tierney, Chicago, IL (US)

(72) Inventors: Michael Blum, Western Springs, IL (US); Jon Ross, Chicago, IL (US); Daniel Tierney, Chicago, IL (US)

(21) Appl. No.: 14/341,771

(22) Filed: Jul. 26, 2014

(51) Int. Cl. G06Q 40/04

(52) U.S. Cl. CPC G06Q 40/04

(57) ABSTRACT

A trading platform comprising a processor and tangible computer readable storage media. The platform may comprise instructions for receiving and processing orders and bids. The platform may store the bids and offers in a bid and offer order book. The platform may group the bids and offers based on price and notional value. The platform may redistribute groupings of bids and offers after a new bid or offer is received in the platform.

### BACKGROUND OF THE INVENTION

The minimum price variation (MPV or tick size) of a security is the smallest pricing increment or amount by which two prices can differ. All prices must be an integer multiple of the MPV. MPV is set by regulators in the US, U.S. Securities and Exchange Commission or trading venues such as NYSE, NASDAQ, BATS to a single static value for any price range of an instrument (e.g. security, debt, commodity, option or future). MPV, tick size, and minimum increment are set by regulators and trading venues set the MPV for an instrument by decree. Determining the optimal MPV or tick size may be difficult in some circumstances and numerous studies have shown that MPV has a sizeable effect on both volatility and efficient liquidity and price formation of an instrument.

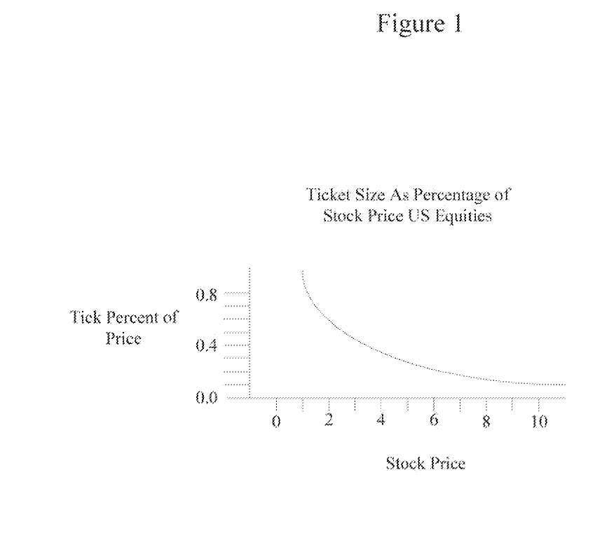

In 2007, as part of the implementation of Regulation NMS (a series of rules promulgated by the SEC designed to modernize and strengthen the national market system for equity securities) the U.S. Securities and Exchange Commission (SEC) established an MPV of one penny ($0.01) for all US equity securities priced above one dollar ($1.00) As the overwhelming majority of listed U.S. stocks trade at prices greater than $1, the one penny minimum tick size essentially applies to all listed stocks in the U.S. As a result of this essentially flat or one-size-fits-all approach, for lower priced securities the MPV or tick size is a greater percentage of the price of the security and for higher priced securities the MPV comprises a lesser percentage of the price of the security, as shown by the graph in FIG. 1.

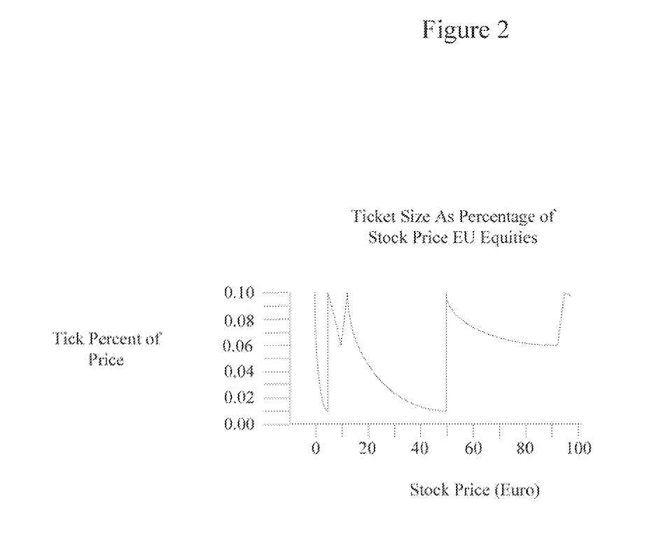

In contrast to the essentially flat tick size regime utilized in the U.S., in Europe there is no governing law setting the MPV to a certain value, so the relevant European regulators or trading venues mutually agree on a tick size for a range of price bands. Currently, the price bands are variable, depending on the country and the price of the stock. So, as a result of the tiered tick size regimes in Europe, in a stepwise fashion, as the price of a security decreases, so does the tick size, as is shown in the graph in FIG. 2.

FIG. 2 features a Y axis that is 10 times smaller than the Y axis for FIG. 1. Thus in Europe, MPV is never more than 0.1% of the price of a security whereas in the U.S., all securities under $10.00 have an MPV that is greater than 0.1% of the price. Inversely, the MPV of a security in Europe is never less than 0.02% of its price whereas in the U.S., all securities above $50.00 have an MPV that is less than 0.02% of their price.

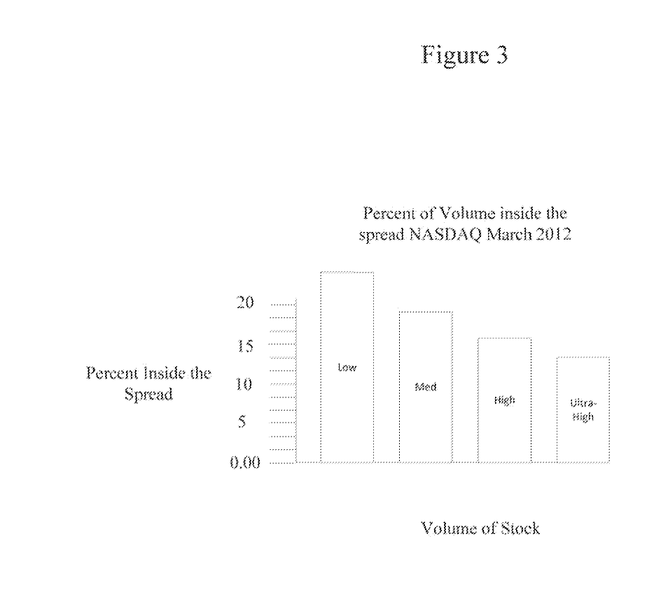

The tiered MPV approach followed in Europe keeps the MPV economically relevant with respect to the price of the security. However, the European approach does not adjust the MPV for the average daily volume (ADV) of trading in a security (a factor having an effect on spread and trading characteristics of the security). In FIG. 3, the relationship between % inside the spread and volume of stock is shown for NASDAQ. “% inside the spread” meaning % of volume traded inside or between the bid/ask spread. Volume of stock is the average daily volume of stocks categorized into bands of low volume, medium volume, high volume and ultra-high volume. As a stock's volume rises, the percentage of shares traded between the bid/ask spread declines. Shares are traded between the bid/ask prices, but outside the bid/ask spread. The inverse relationship between volume and % shares traded within spread holds true even though the average price of the security is similar across volume ranges.

Industry observers have argued that market forces, instead of regulators and trading venues, should determine optimal tick size. For example, one could a larger MVP for low volume securities to incentivize better price formation in those securities and smaller tick size in high volume securities. In practice, however, determining the optimal MPV based on trading volume of a security would be problematic, as whoever sets the tick size would need to know the day's trading activity in advance to properly set volume-based MPV tables. Moreover, the intra-day trading volume of a security can vary greatly, and a static volume-based MVP would be sub-optimal for parts of the trading day.

Thus, there is a need for a system and method to dynamically discover and adjust the appropriate MPV or tick size for any instrument traded in a continuous market.

### SUMMARY OF THE INVENTION

A server comprising a processor and tangible computer readable storage media comprising instructions for the processor to execute a trading platform comprising multiple components such as a notional constraint, bid receiver, bid order book organizer, and a bid notional book organizer is disclosed. With respect to bids, the notional constraint may be used by the bid notional book organizer to separate bids into one or more bid groups. The bid receiver may be configured to receive a plurality of bids to purchase shares of a security at a bid price, each bid may have a notional value. The bid order book organizer may be configured to maintain bids in a bid order book in price order. The bid notional book organizer may be configured to: create a first group of bids from the plurality of bids by: selecting from the plurality of bids, a first bid having a highest price; storing the first bid into the bid notional book as first group if the first bid has a notional value greater than the notional constraint, if not, selecting from the plurality of bids, a second bid having a next highest price and determining whether a cumulative notional value of the first and second bid is greater than the notional constraint, and storing the first and second bid as a first group if the first bid and second bid have a cumulative notional value greater than a notional constraint. The bid notional book organizer may be further configured to: select from the plurality of bids, n bids and determine whether a cumulative notional value of the n bids is greater than the notional constraint, if the first and second bid has a cumulative notional value less than a notional constraint, and store the n bids as a first group, if the n bids have a cumulative notional value greater than a notional constraint; n may be an integer greater than 2.

The trading platform may contain additional components and have additional configurations as follows. The trading platform may comprise a match analyzer configured to: send a bid having a price greater than or equal to the best offer to a bid executor configured to execute the bid; and send a bid having a price less than the best offer to a bid order book. The bid order book organizer may be configured to maintain the bid order book by sorting the book by price, or inserting the bid into the book such that the resulting book is in price order without sorting. The bid notional book organizer may be configured to determine the bid having a lowest price in the first group, and set a first group bid price for the first group equal to the lowest price. The bid notional book organizer may be configured to determine the bid having a lowest price in the second group, and set a second group bid price for the second group equal to the lowest price. The bid notional book organizer may be configured to set a best bid equal to the first group bid price.

The bid notional book organizer may be configured to receive a plurality of bids from the bid order book in price order. The bid notional book organizer may be configured to create a second group of bids from the plurality of bids by: selecting from the plurality of bids, a first highest bid not in the first bid group and determining whether the notional value of the first highest bid is greater than the notional constraint, and storing the first highest bid as a second group if the first highest bid has a notional value greater than a notional constraint. If not, the organizer may be configured to select from the plurality of bids, a second highest bid not in the first bid group and determine whether a cumulative notional value of the first and second highest bid is greater than the notional constraint, and store the first and second bid as a second group if the first and second highest bid has a notional value greater than a notional constraint. The organizer may store the first highest bid not in the first group, into the bid notional book as second group, if the first highest bid not in the first group has a notional value greater than the notional constraint. If not, the organizer may select from the plurality of bids, n bids having highest bids not in the first group and determine whether a cumulative notional value of the n bids is greater than the notional constraint, and store the n bids as a second group, if the n bids have a cumulative notional value less than a notional constraint.

In another configuration, a server comprising a processor and tangible computer readable storage media is disclosed. The storage media comprising instructions for the processor to execute a trading platform. The trading platform may comprise: a notional constraint; a bid order book; a best bid module for receiving a best bid; a best offer module for receiving a best offer; a bid receiver for receiving a plurality of bids to purchase shares of a security at a bid price, each bid having a notional value; a bid processor configured to determine whether there is an outstanding offer that is less than or equal to the bid; a bid placer configured to place the bid into the bid order book; and a bid storer configured to store the bid as an unplaced bid in the bid order book, if the bid is not placed. The bid processor configured to place at least one of the unplaced bids into the bid notional book, if an aggregate of the notional values of the unplaced bids in the data store has an aggregated notional value greater than or equal to the notional constraint, else not placing any of the unplaced bids. The bid processor may be configured to store bids which are not placed in the bid notional book into the bid order book.

The trading platform may comprise a bid decider configured to award execution priority to at least one of the bids stored in the bid order book. The trading platform may comprise a tick size module for determining or receiving a tick size; and the bid placer may be configured to: place the bid into the bid order book if the bid price is equal to the best bid plus an additional amount, wherein the additional amount is equal to a multiple of the tick size; place the bid if the bid price is equal to the national best bid plus an additional amount, wherein the additional amount is less than the tick size, but the notional value of the bid is greater than the notional constraint.

The trading platform may be configured to receive two of the received bids at different times; and the bid decider may be configured to award execution priority to the bid received first in time. The trading platform may be configured to receive two of the received bids at different times; and the bid decider may be configured to award priority to the bid proposed last in time. The trading platform may be configured to receive bids at different associated prices, and the bid decider may be configured to award priority to the bid received with a higher price. The trading platform may be configured to receive at least two of the proposed bids are proposed with different notional values; and the bid decider is configured to award priority to the bid having a higher notional value. The trading platform may be configured to receive a first, second, and third bid are received, wherein a sum of the notional values of the first and second bid are less than the notional constraint, but a sum of the notational values of all three bids is greater than or equal to the notional constraint. The bid decider may be configured to select the third bid. The trading platform may comprise an offer receiver for receiving a plurality of offers to sell shares of a security at an offered price, each offer having a notional value. The bid processor may be configured to: place a received offer, if the price offered is equal to the national best offer; place at least one of the received offers into the bid notional book, if at least one offer has a price less than the best offer into the bid notional book, and an aggregate of the notional values of the offers has a price greater than or equal to the notional constraint. Else, the bid processor may not place a received offer into the bid notional book.

In another configuration a server comprising a processor and tangible computer readable storage media is provided. The storage media comprising instructions for the processor to execute a trading platform which may comprise: a notional constraint used by the platform to group bids and offers for a security; a bid order book configured to store bids received by the platform, each bid having a notional value and a price; a bid order book organizer configured to sort the bids in price order; a bid notional book configured to store bid groups, wherein bids in each bid group may have a cumulative notional value greater than the notional constraint, and each bid group may have a bid group price; a bid notional book organizer which may be configured to: set the bid group price equal to the bid having a lowest price in the bid group, and arrange the bid groups in price order. The platform may comprise a public view determination module configured to select a bid group having a highest bid group price as a best bid. The platform may comprise an offer order book configured to store offers received by the platform; each offer may have a notional value and a price. The platform may comprise: an offer order book organizer configured to sort the offers in price order; an offer notional book configured to store offer groups, wherein offers in each offer group have a cumulative notional value greater than the notional constraint, and each offer group has an offer group price. The platform may comprise an offer notional book organizer configured to: set the offer group price equal to the bid having a lowest price in the group, and arrange the offer groups in price order. The platform may comprise a public view determination module configured to select an offer group having a highest offer group price as a best offer.

A process of steps executable by a server comprising a processor and tangible computer readable storage media is disclosed. The storage media stores the process of steps, and the processor is configured to execute the steps. The process may comprise: if an offer has a notional value greater than a notional constraint: placing the offer into an offer notional book; placing the offer into an offer order book; and removing the offer from the offer order book and offer notional book if the offer is executed. If not, storing the offer into the offer order book. The process may also comprise: storing a set of offers in the offer order book; and placing a set of offers into the notional book and offer order book if the set of offers have a cumulative notional value greater than the notional constraint. The process may comprise receiving a bid for a security with a bid receiver; matching the bid to an offer having a value less than or equal to the bid; removing at least one offer from the offer order book; and removing at least one offer from the offer notional book. The process may comprise: receiving an offer equal to the best offer; the offer having a notional value, and the best offer having a cumulative notional value; adding the notional value of the offer to the best offer notional value; and adding the offer to the offer notional book and the offer order book.

A server comprising a processor and tangible computer readable storage media. The storage media comprising instructions for the processor to execute a trading platform. The trading platform may comprise: a best bid book comprising: a bid group price, a bid cumulative notional value, one or more best bids, each bid may have a bid placement time, a bid price greater than or equal to the group price, and a notional value. The platform may comprise: an offer receiver for receiving a first offer; a matching engine configured to determine whether the first offer is less than the bid group price; an offer executer configured to execute a transaction involving the first offer, and at least one offer from the best bid book; and a bid decider configured to determine which bid or bids from the best bid book to select for the transaction involving the first bid, The platform may comprise a bid order book organizer configured to: receive a notification of the transaction; remove the bid or bids selected by the bid decider from a bid order book; and sort the bid order book so that the bids are placed are sorted in price order. The trading platform may comprise a bid notional book organizer configured to: receive notification of the transaction; remove the bid or bids selected by the bid decider from a bid notional book; and update group information of bid groups in the bid notional book.

The notional book organizer may be configured to: group a set of bids as a bid group if the bids within a first price band have a cumulative notional value greater than or equal to a notional constraint; else group a larger set of bids as a bid group if the bids within the first price band and bids within a second price band have a cumulative notional value greater than or equal to a notional constraint; wherein the second price band is lower than the first price band. The bid decider may be configured to select a bid having a bid price higher than all other bids in the best bid book. The bid decider may be configured to select a bid having a bid placement time earlier than all other bids in the best bid book. The trading platform may comprise a best offer book comprising: an offer group price; an offer cumulative notional value; one or more best offers, each offer having an offer placement time, an offer price less than or equal to the group price, and a notional value. The trading platform may comprise bid order book organizer further configured to receive a first bid; determine a slot position in the bid book for the first bid; and send bids in the bid books to the bid notional book organizer. The bid notional book organizer may be configured to: receive bids from the bid order book organizer; determine bid groups for the received bids; organize the bids into the bid groups; each bid group having bid group price and a bid group notional value, wherein the bid group notional value is greater than or equal to a bid group notional constraint. The best bid module may be further configured to identify the bid group having the highest bid group price.

A server comprising a processor and tangible computer readable storage media is disclosed. The storage media may comprise instructions for the processor to execute a trading platform comprising a bid notional book organizer for performing an organization process on a bid notional book. The bid notional book may comprises a plurality of bids distributed into a plurality of bid groups, and the organizer may be configured to: remove a bid from the bid notional book; determine that the bids in the bid notional book are distributed correctly if one or more bids at a highest priced bid group has a cumulative notional value greater than or equal to the notional constraint; else, select one or more bids at a next highest price band, and determine whether the one or more bids in the highest priced bid group plus the one or more bids at the next highest price band have a cumulative notional value greater than or equal to the notional constraint. If so, the organizer may form a first bid group of the highest bid group and the bids in the next highest price band; else select bids in progressively lower priced price bands until a sum of the notional values is greater than or equal to the notional constraint, and form a first bid group of all bids needed to satisfy the notional constraint.

The bid notional book organizer may be configured to: select one or more highest priced bids not in first bid group, the one or more bids having the same price; determine that the bids in the bid notional book are distributed correctly if the one or more highest priced bids not in first group have a cumulative notional value greater than or equal to the notional constraint. Else, select one or more bids at a next highest price band not in the first bid group, and determine whether the one or more highest priced bids not in first bid group and the one or more bids at the next highest price band not in the first bid group have a cumulative notional value greater than or equal to the notional constraint. If so, form a second bid group of the one or more highest priced bids not in first bid group and the one or more bids at a next highest price band not in the first bid group; else select bids in progressively lower priced price bands until a sum of the notional values is greater than or equal to the notional constraint and form a second bid group of all bids needed to satisfy the notional constraint. The organizer may be configured to: determine one or more next highest priced bid not in the first or second bid group, and place the one or more next highest price bids in an next bid group if a sum of the notional constraints of the one or more next highest price bids is greater than the constraint, else select progressively lower priced bids to increase how many bids are in the next bid group; and form the next bid group once a cumulative value of the bids in the next group exceeds a notional constraint. The organizer may be configured to determine whether the book comprises a sticky, semisticky, or nonsticky ordering type.

A server comprising a processor and tangible computer readable storage media is disclosed. The storage media comprising instructions for the processor to execute a trading platform that may comprise a bid order book organizer for organizing a bid order book, the organizer configured to insert incoming bids into the bid organizer book such that bids are placed in price order; and if two or more bids have the same price, place the bids having the same price in time of receipt order. The platform may comprise a bid notional book organizer for organizing a bid notional book. The bid notional book organizer may be configured to: receive a set of bids from the bid order book organizer, and determine bid groups for bids in the set, each bid group having a cumulative notional value greater than a notional constraint; and determine a bid group price for each bid group, the bid group price being equal to a bid price of a lowest bid in the bid group. The bid notional organizer may be further configured to place as top of book, the bid having the highest price in the highest priced group. The bid notional book organizer may be further configured to place as top of book, the bid having an earliest arrival time in the highest priced group. The bid notional book organizer may be configured to place as top of book, the bid having a largest notional value in the highest priced group.

A server comprising a processor and tangible computer readable storage media is disclosed. The storage media comprising instructions for the processor to execute a trading platform that may comprise a bid and offer analyzer configured to receive an offer; a matching engine configured to receive the offer and determine whether there is a matching bid in a bid notional book; an order executer for selecting one or bids from the bid notional book to execute with the offer; a bid remover configured to remove the executed bids from the bid notional book and a bid order book; and a bid notional book organizer configured to redistribute bid groupings once the executed bids have been removed from the bid notional book. The trading platform may comprise a bid order book organizer configured to maintain a sorted list of current bids in a bid order book.

### BRIEF DESCRIPTION

FIG. 1 shows a graph of tick size as a percent of price vs stock price in U.S. equities.

FIG. 2 shows a graph of tick size as a percent of price vs stock price in European equities.

FIG. 3 shows the relationship between percent inside the spread and volume of stock.

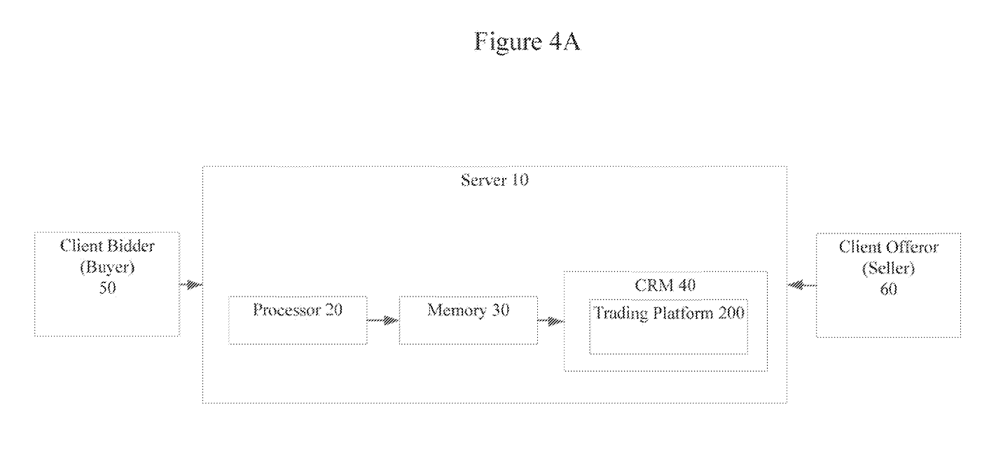

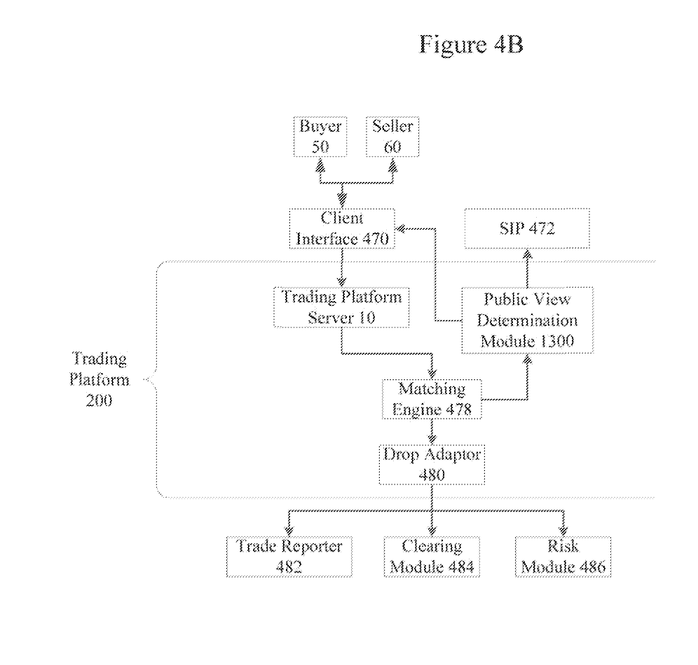

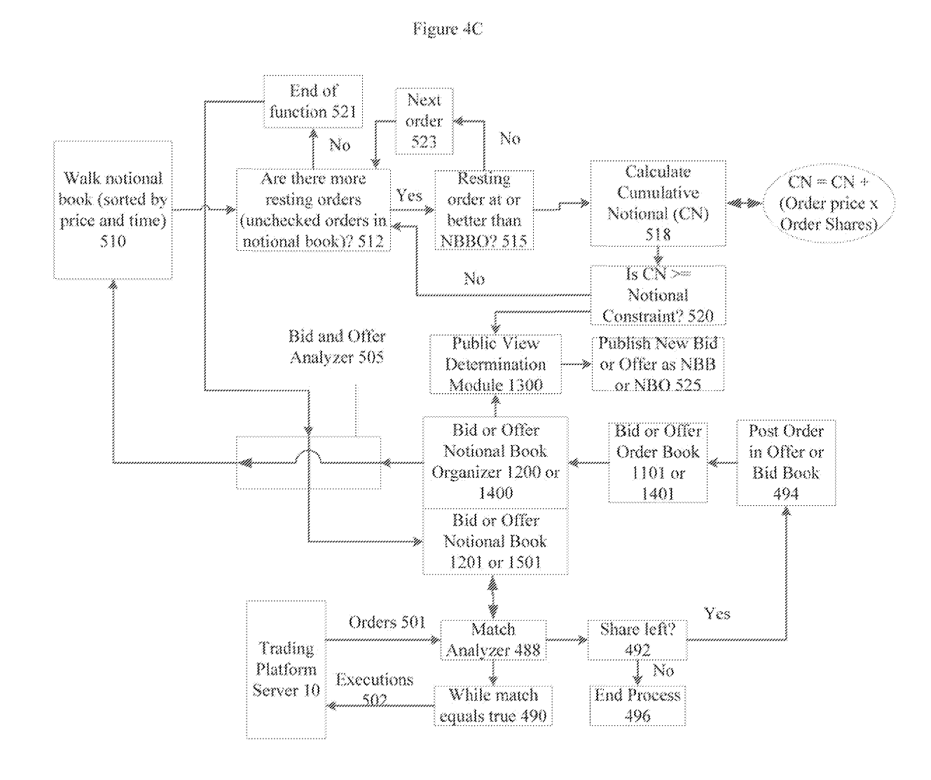

FIG. 4A shows a hardware schematic of a server running the trading platform.

FIG. 4B shows a schematic view of the trading platform.

FIG. 4C is a process flow diagram for processing orders in the trading platform.

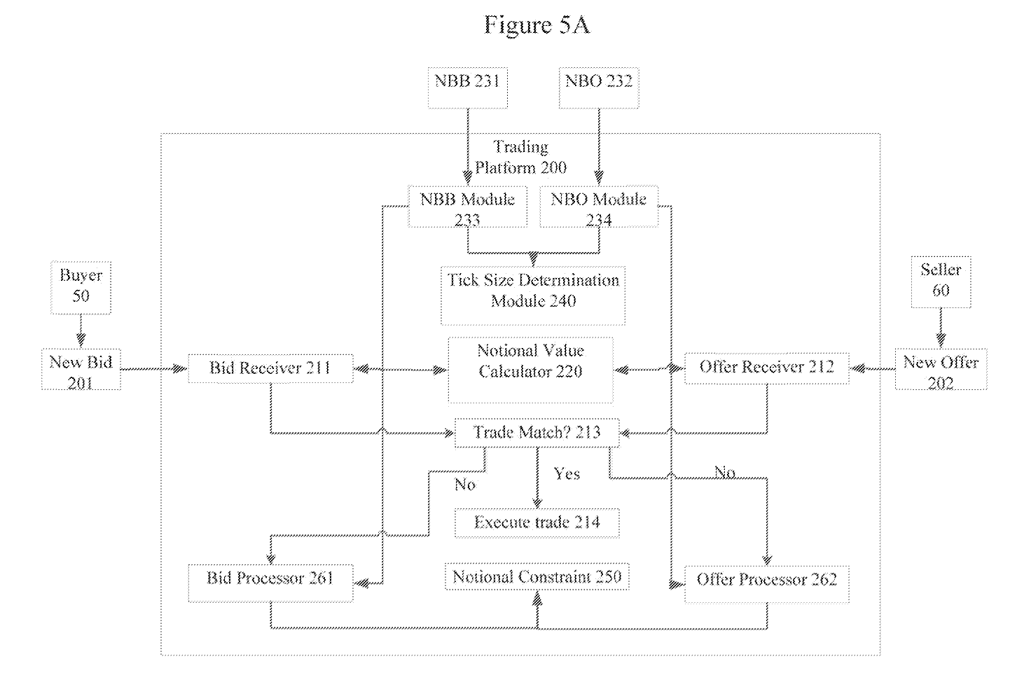

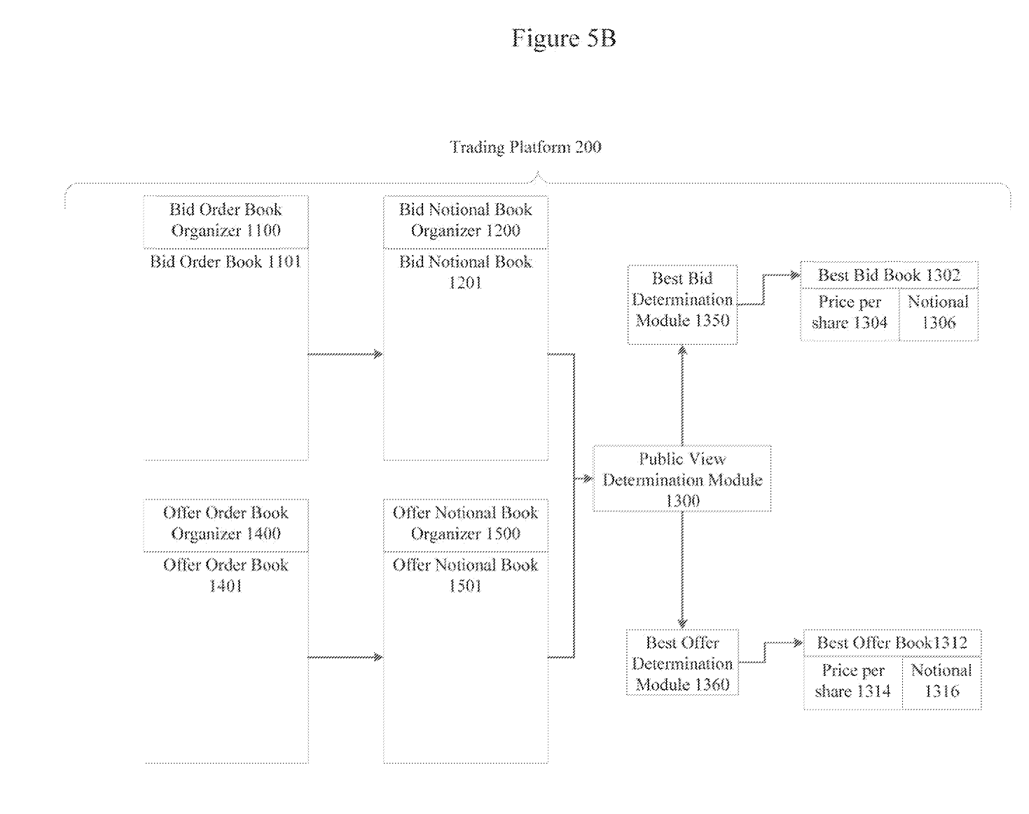

FIG. 5A shows a schematic of a trading platform illustrating both a bid receiver and an offer receiver.

FIG. 5B shows a schematic of the trading platform.

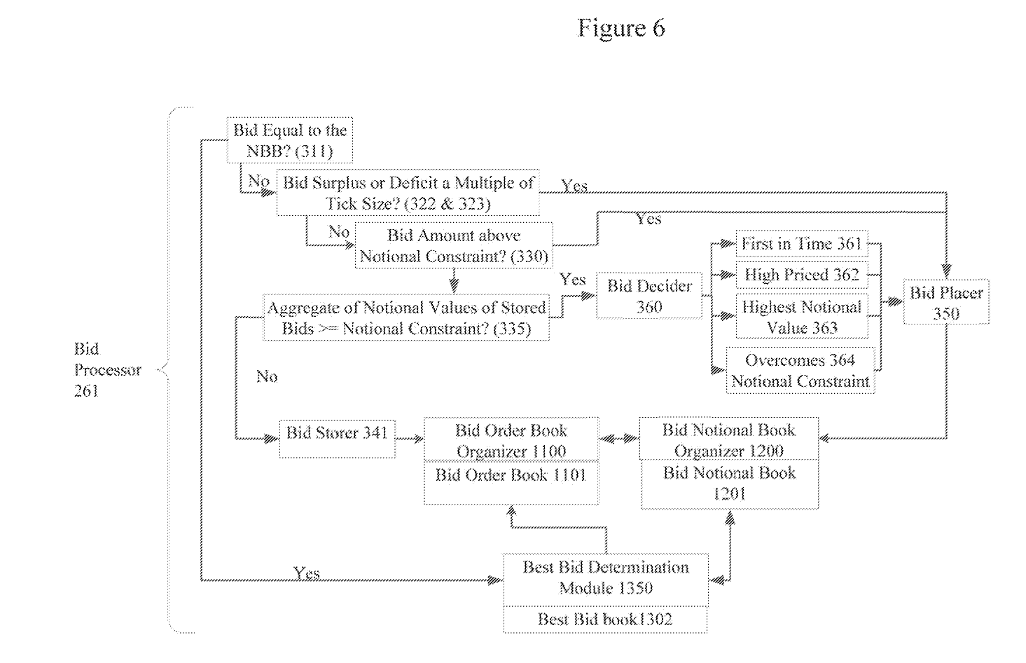

FIG. 6 shows a schematic illustrating the details of the bid processor.

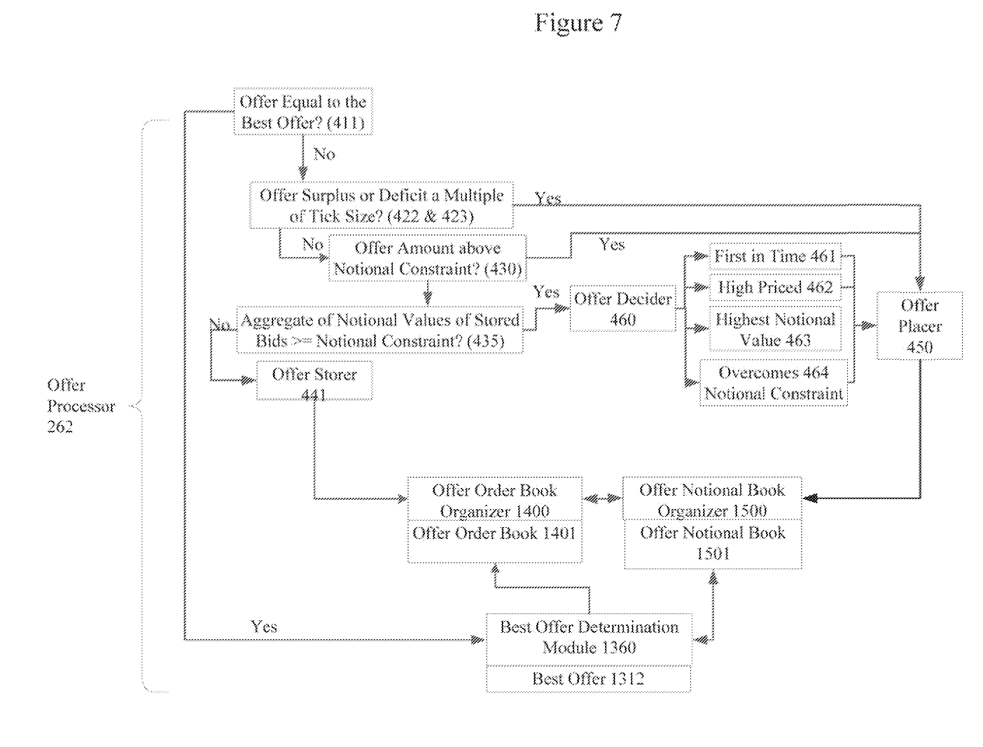

FIG. 7 shows a schematic illustrating the details of the offer processor.

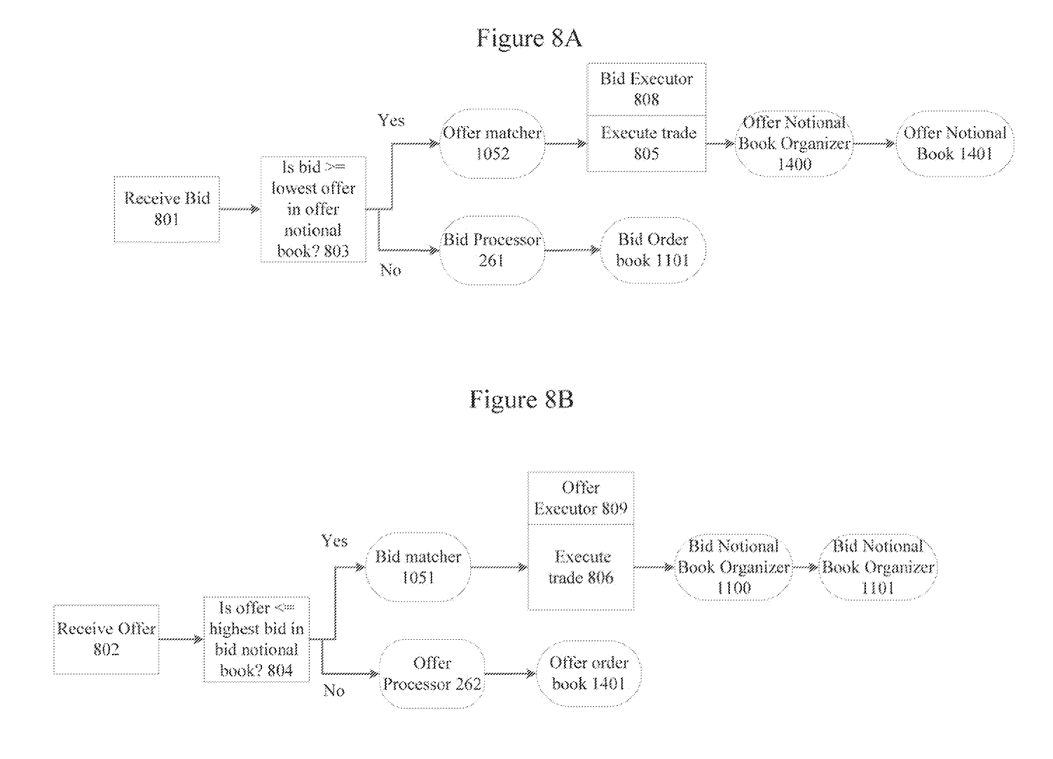

FIGS. 8A and 8B shows process flow diagrams of bids and offers received by the trading platform.

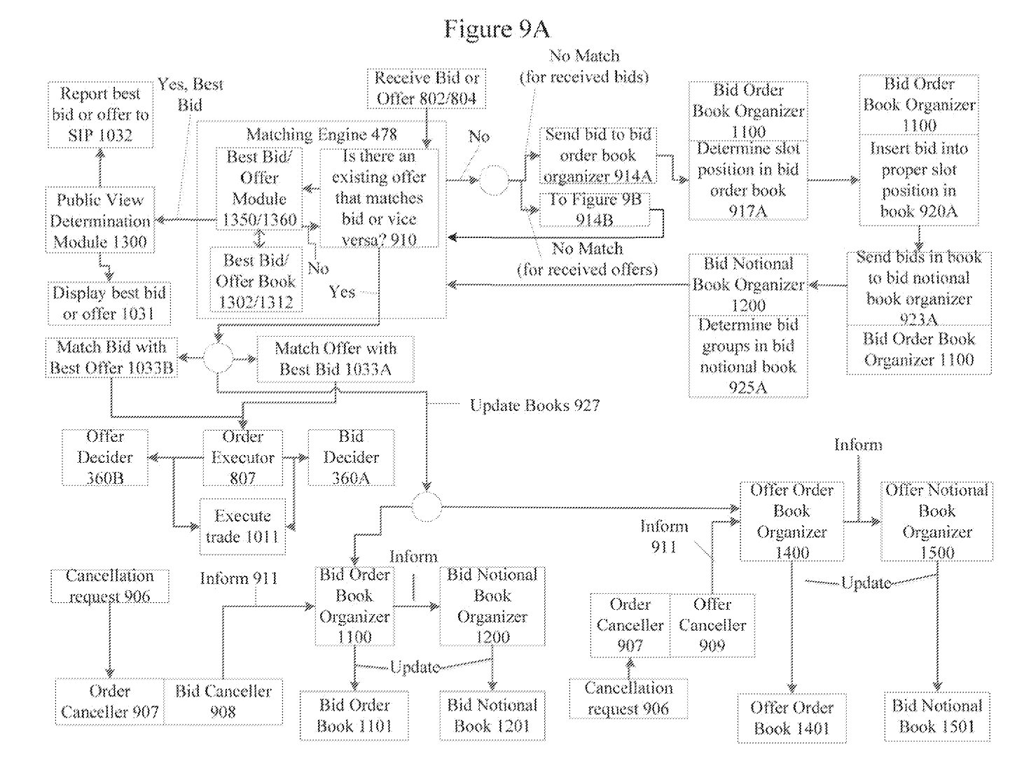

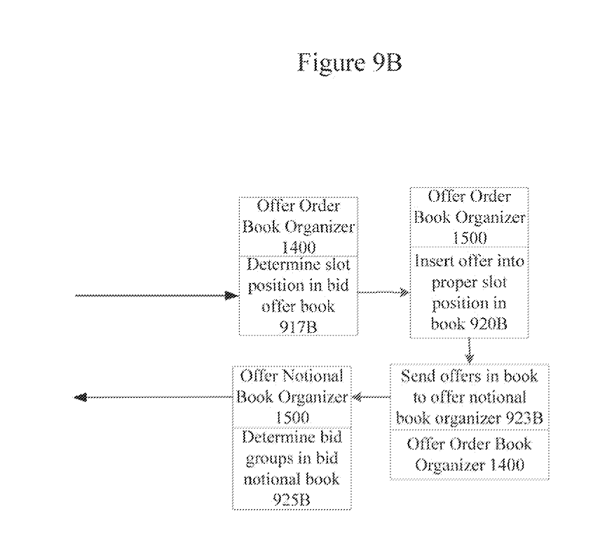

FIG. 9A shows modules and processes controlled by the trading platform. FIG. 9B shows processes 914-925 for a received offer.

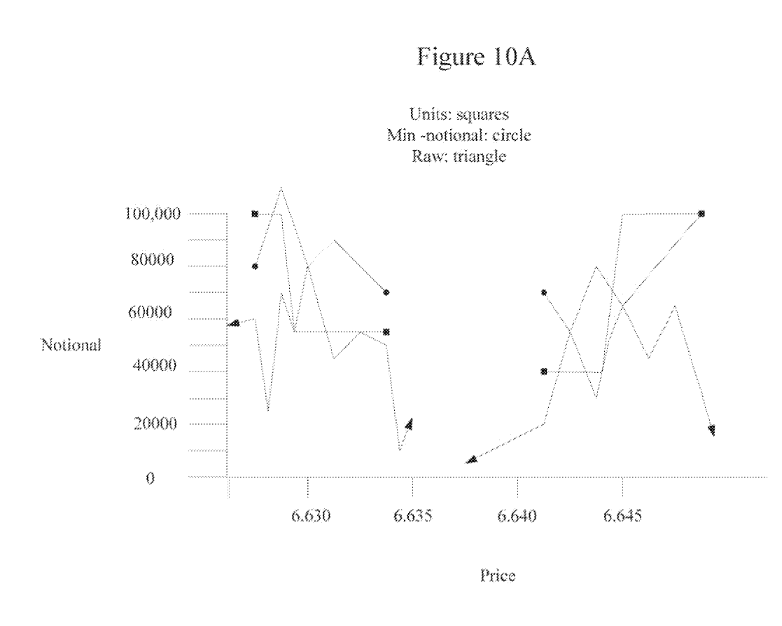

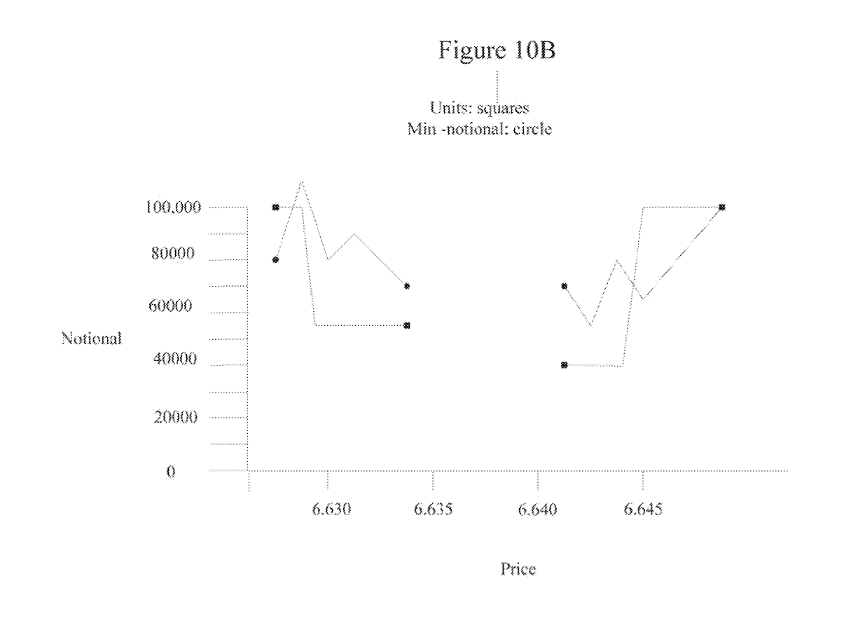

FIG. 10A shows a graph of the notional and price. FIG. 10B also shows a graph of notional and price, but omits the raw data points.

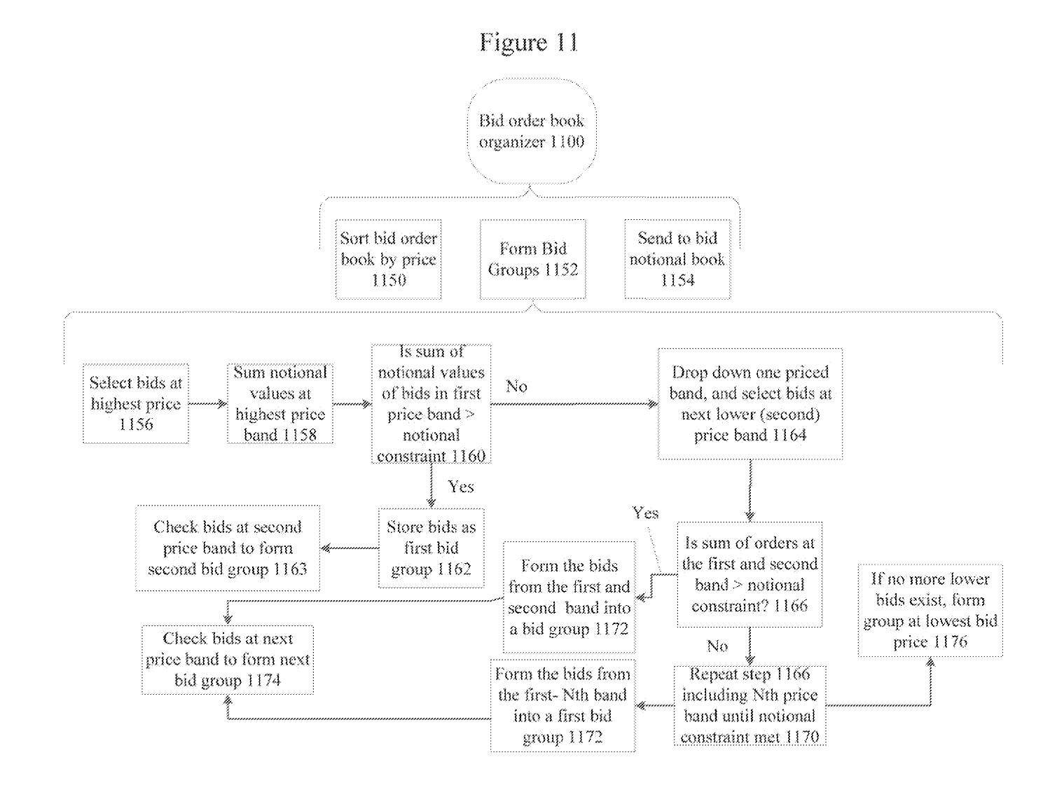

FIG. 11 shows a process flow diagram of the bid order book organizer.

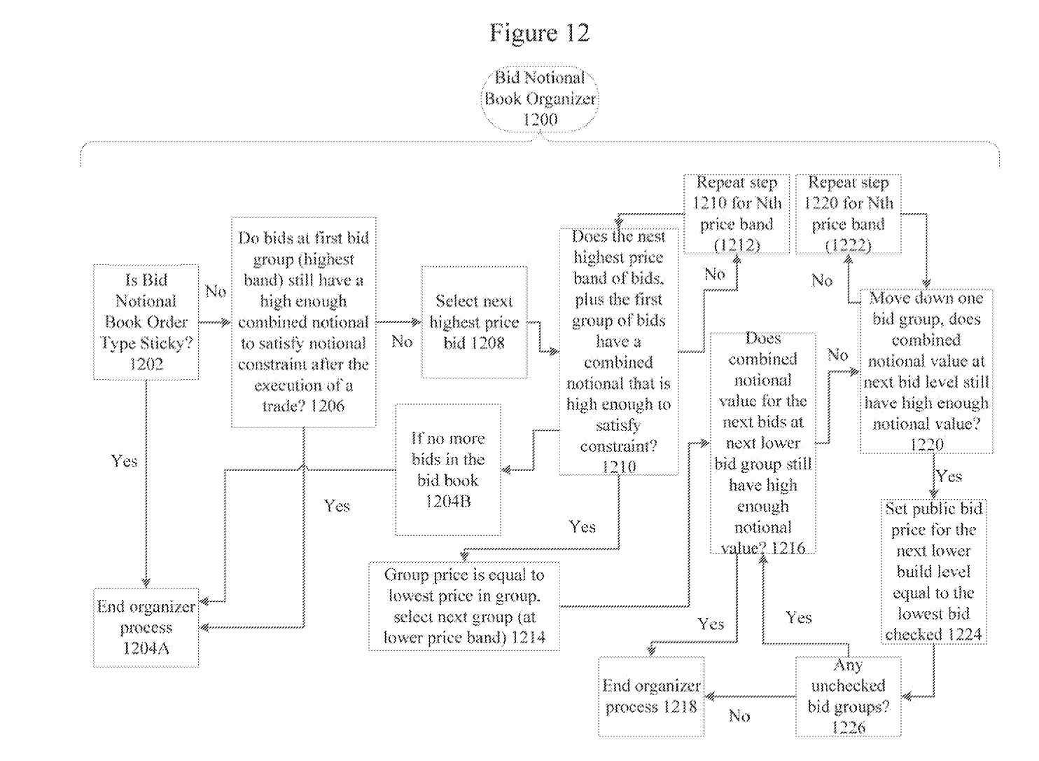

FIG. 12 shows a process flow diagram of the bid notional book organizer.

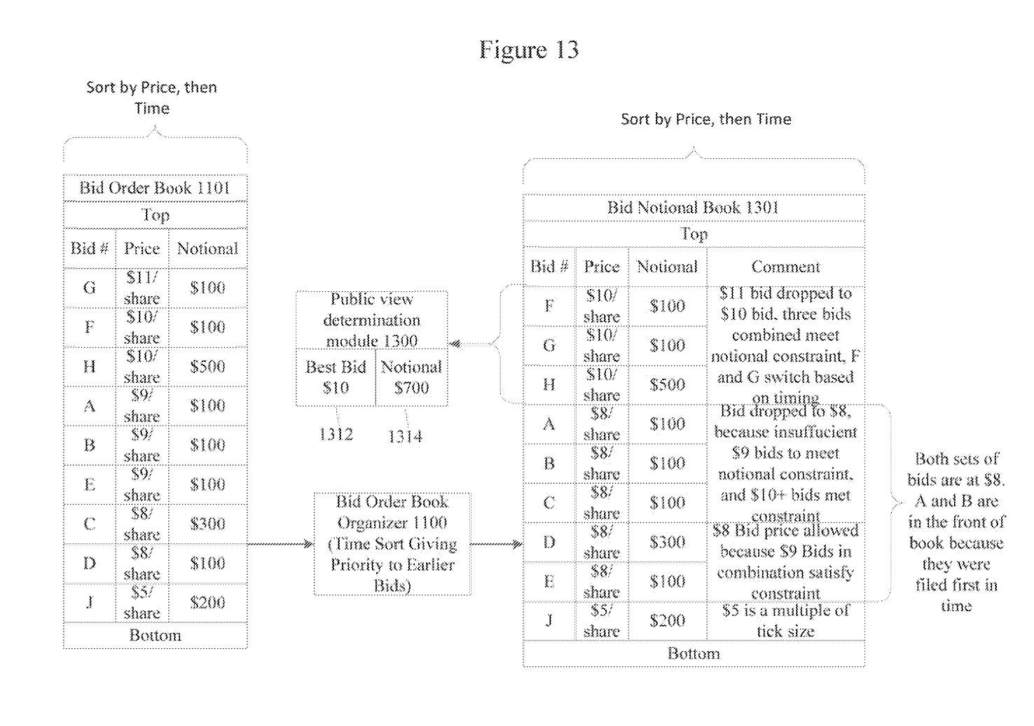

FIG. 13 shows an exemplary process flow of orders A-J that are sorted into the proposed queue, and then processed by the proposed queue redistribution function so that bid time creates priority in the public queue (or bid book).

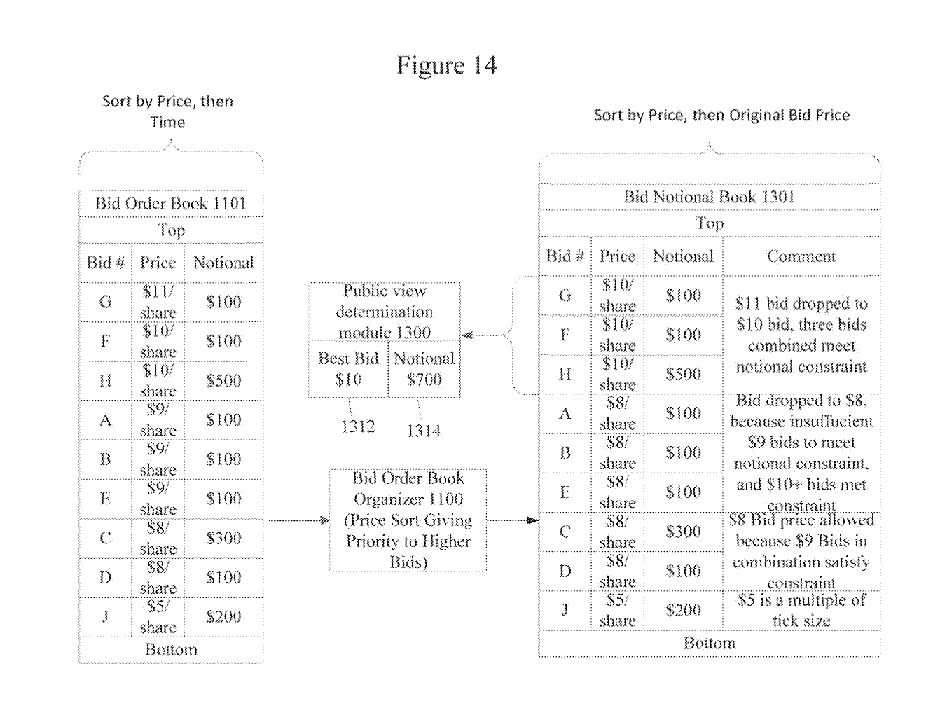

FIG. 14 shows an exemplary process flow of orders A-J that are sorted into the proposed queue, and then processed by the proposed queue redistribution function so that bid price creates priority in the public queue (or bid book).

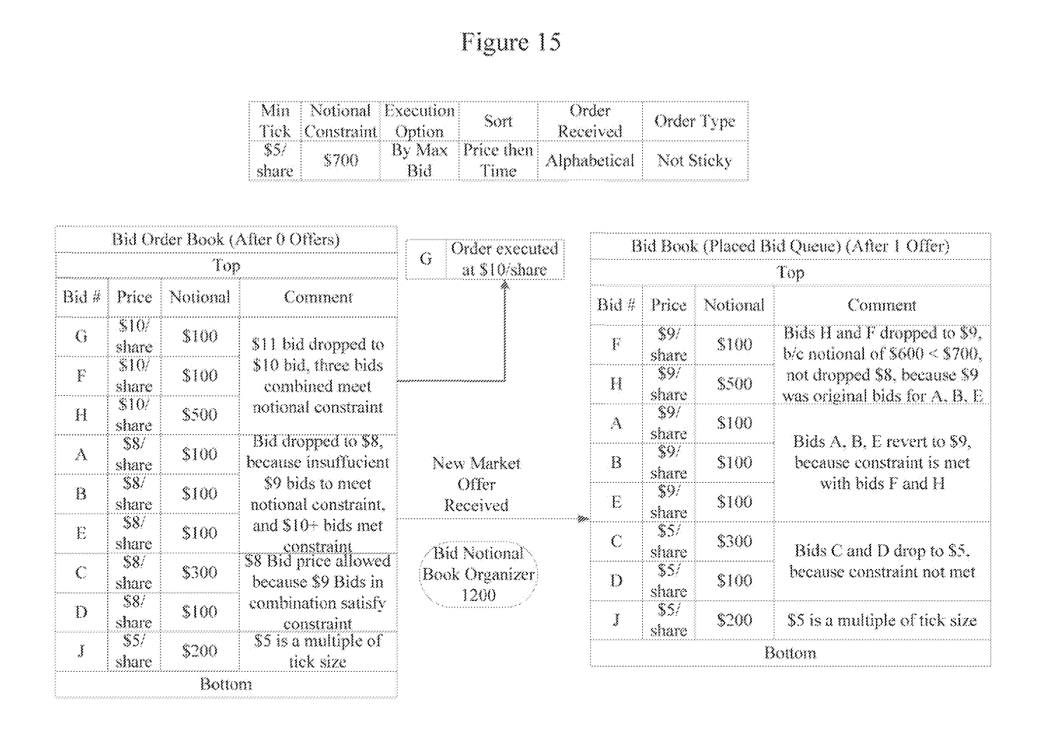

FIG. 15 shows a process flow for a new market order being received by the trading platform wherein the public queue redistribution function uses a non sticky order type.

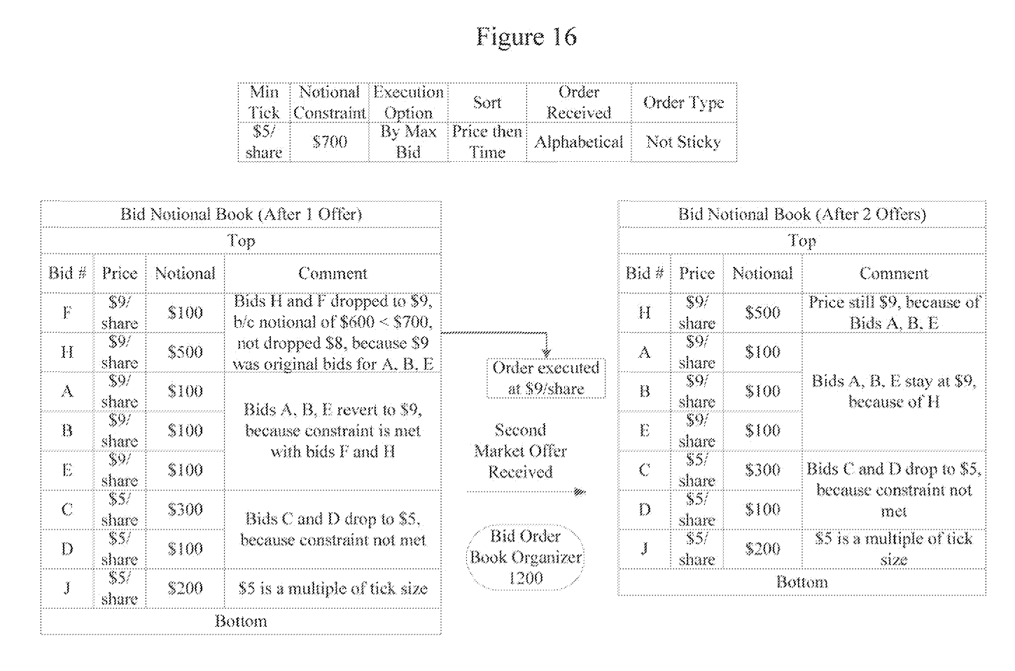

FIG. 16 shows a process flow for a second market order being received by the trading platform wherein the public queue redistribution function uses a non sticky order type.

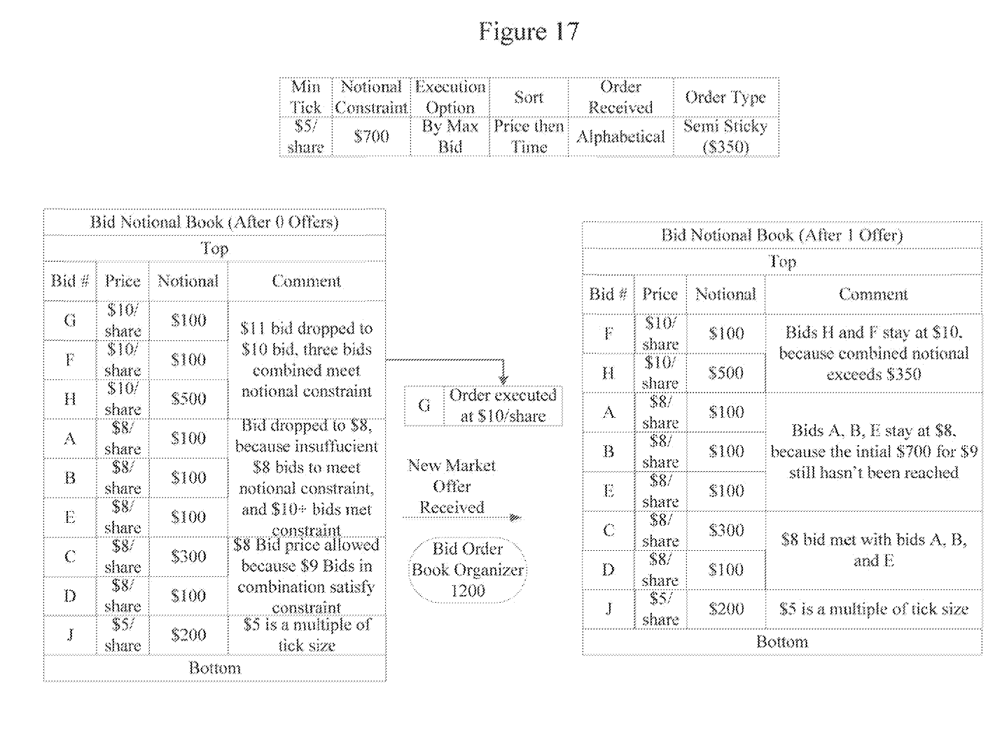

FIG. 17 shows a process flow for a new market order being received by the trading platform wherein the public queue redistribution function uses a semi sticky order type.

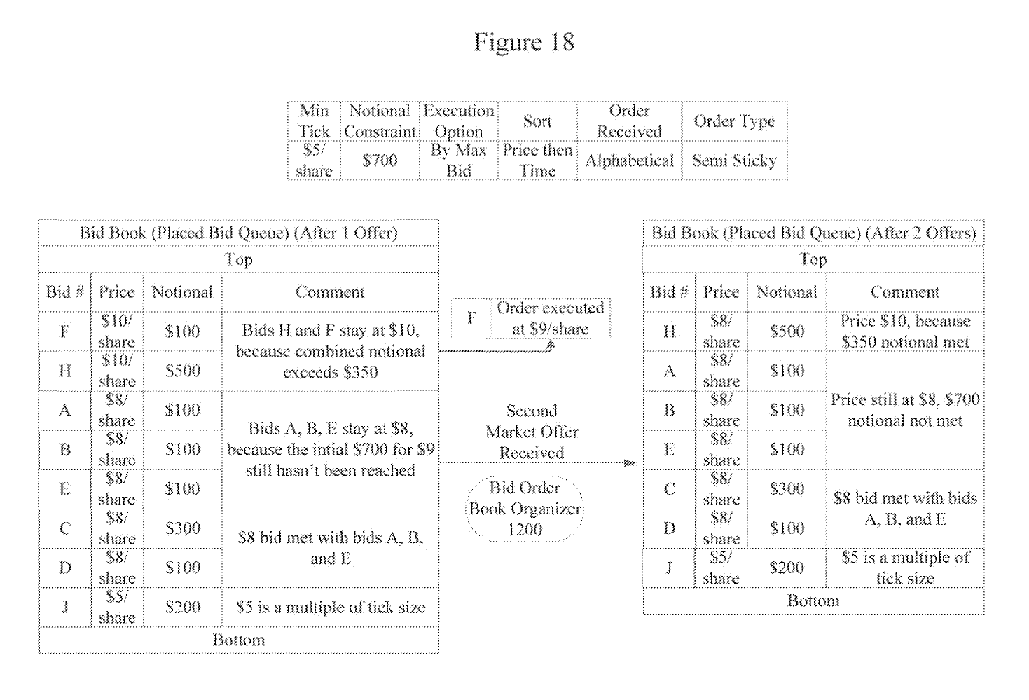

FIG. 18 shows a process flow for a second market order being received by the trading platform wherein the public queue redistribution function uses a semi sticky order type.

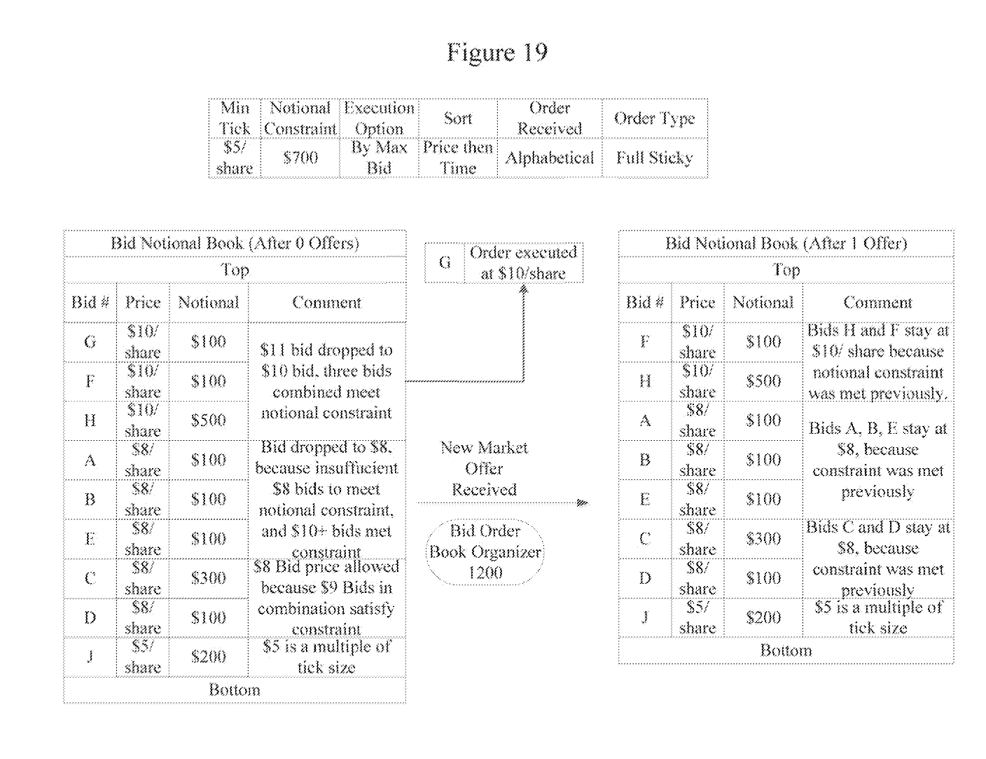

FIG. 19 shows a process flow for a new market order being received by the trading platform wherein the public queue redistribution function uses a full sticky order type.

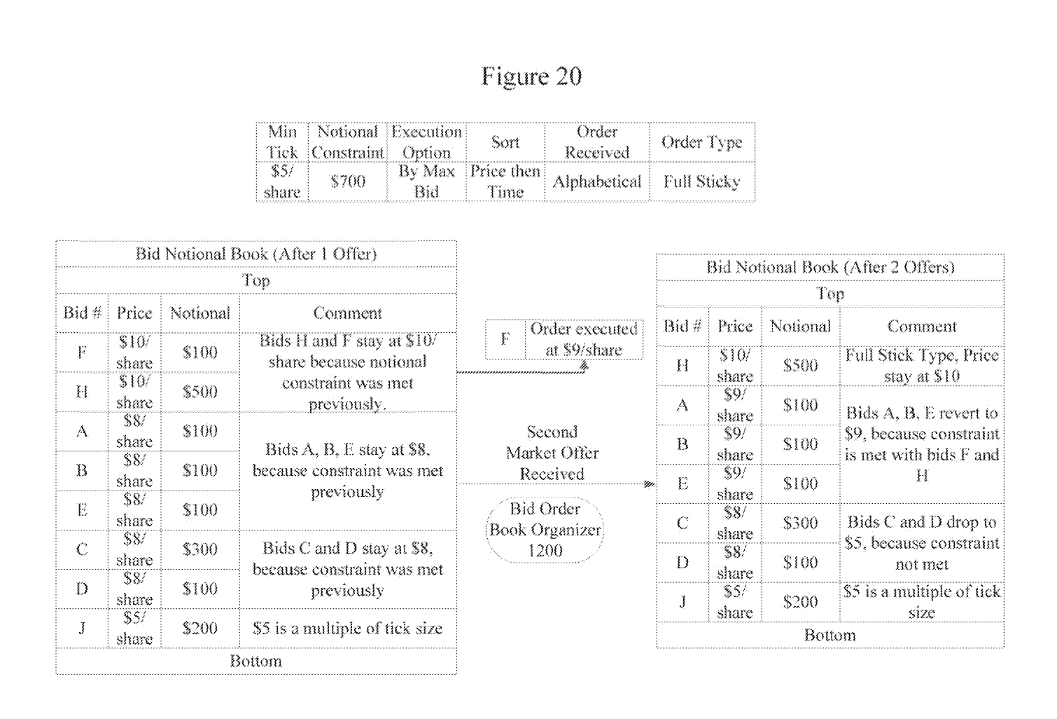

FIG. 20 shows a process flow for a second market order being received by the trading platform wherein the public queue redistribution function uses a full sticky order type.

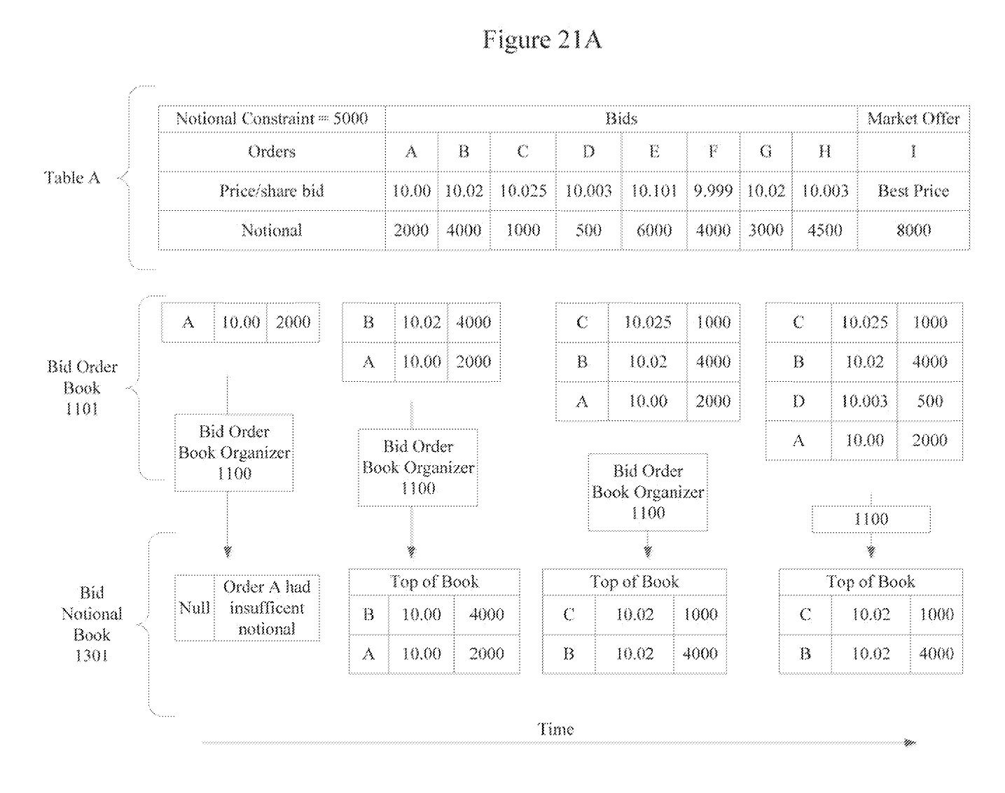

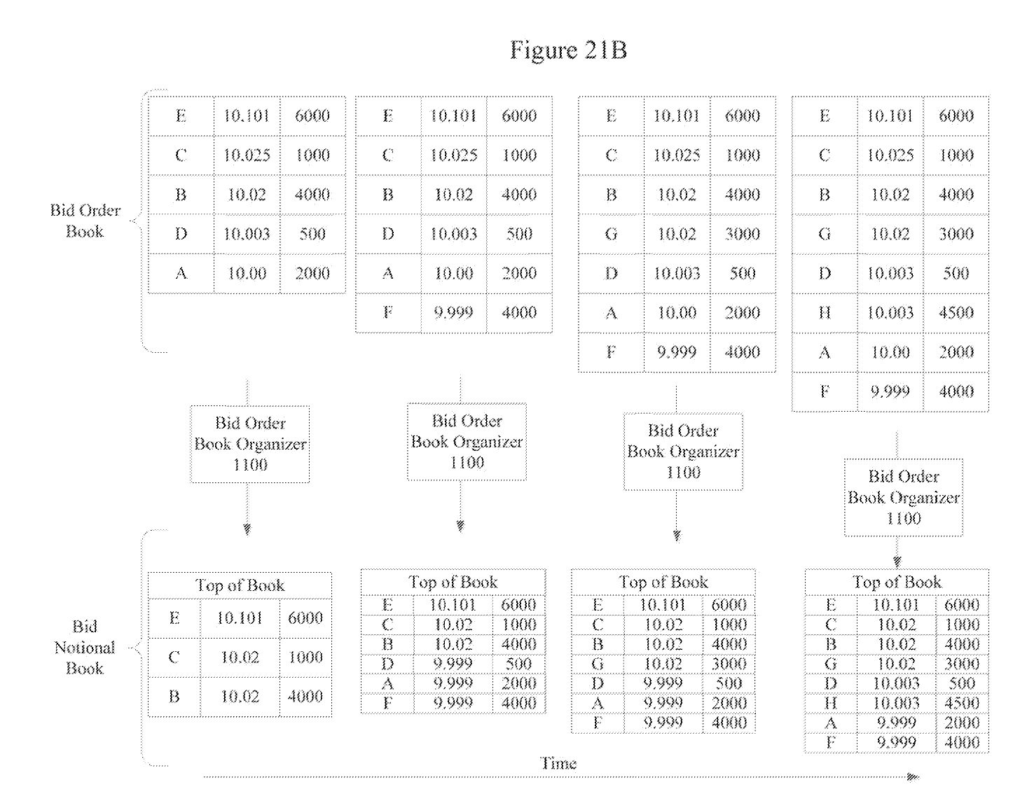

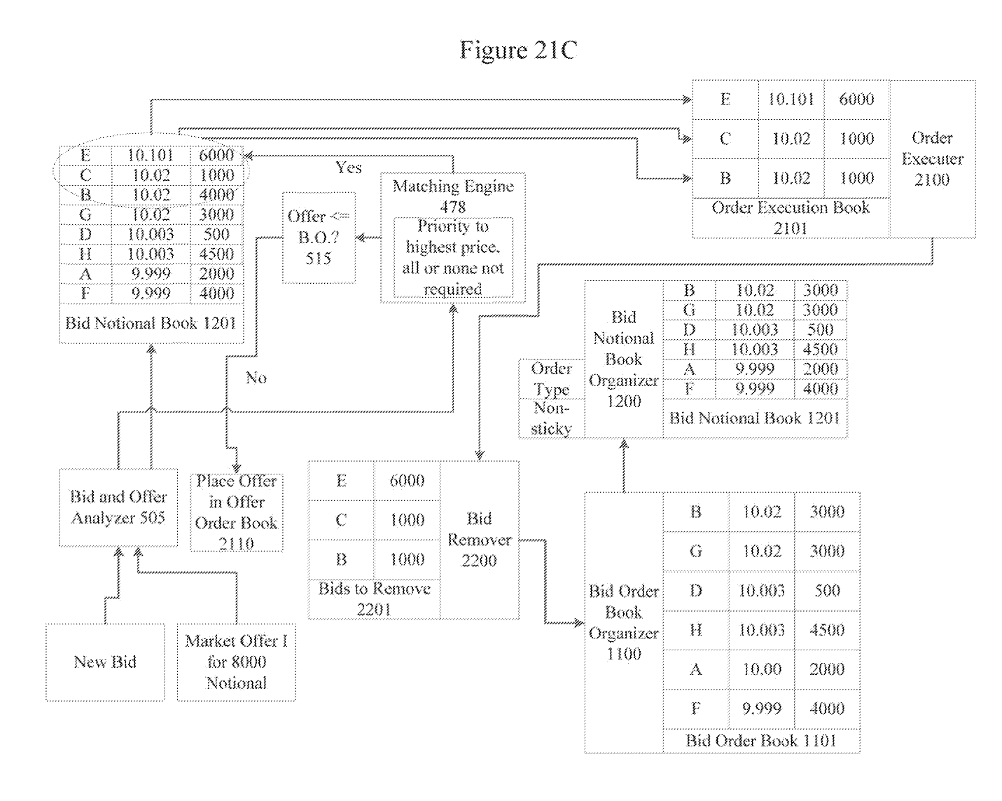

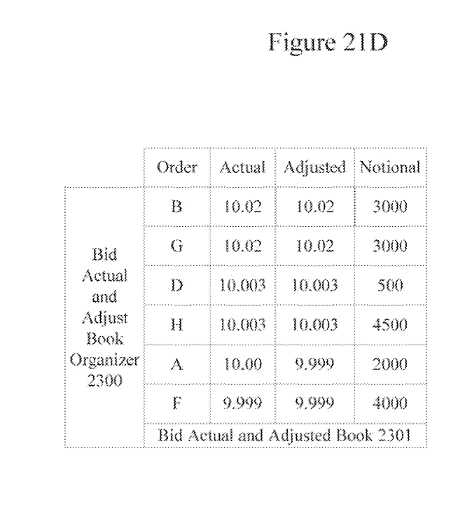

FIGS. 21A-C shows a process flow of receiving offers and bids with the trading platform.

FIG. 21D shows a combined bid order book and bid notional book

### DETAILED DESCRIPTION

The trading platform discussed below can be used to trade assets like securities, futures, derivatives, options, stocks, instruments, etc. In some cases, a broker may act on behalf of the buyer or seller in accessing this platform or the buyer or seller may use the platform directly. Typically, a buyer places a bid for an instrument (such as a commodity or stock), and the price of the bid may be more, less, or equal to the national best bid. A bid less than the national best bid might not be filled until higher bids are filled, since the trading platform may be designed to match incoming market offers against the highest bid. A bid at the current best bid will likely be filled once a seller enters a market offer to sell the security.

Taking a simple example, stock X is trading at a current price of approximately $10 per share. Assume for this stock, that the MPV or tick size is $1 (in contrast, the current tick size for stocks in the US is 1 penny) and the national best bid (NBB) is $9 and national best offer (NBO) is $11. This means that individuals have submitted bids to the trading platform to buy the stock at $9 per share and individuals have submitted offers to one or more financial systems to sell the stock at $11 share. If the financial systems were configured such that the minimum tick size was $1, the next lowest price a seller could offer to sell the stock would be $10, and the next highest price a seller could offer to sell the stock would be $12. Similarly, the next lowest price a buyer could bid to buy the security would be $8, and the next highest price a buyer could bid would be $10.

In the US, Regulation NMS Rule 612 (“Sub-Penny Rule”) currently establishes an MPV of $0.01 for all US equity securities priced above $1.00. In addition to determining the minimum pricing increment by which two prices can differ (e.g., a bid of $10.01 and the next higher bid of $10.02), it also determines the minimum transaction cost for entering and exiting a position, which is referred to as the spread between the national best bid and the national best offer (NBBO spread). With an MPV of $0.01 the spread or difference between the NBB and NBO could be as little as $0.01. When it established an MPV of $0.01 when implementing the Sub-Penny Rule, the SEC noted concerns with the potential of sub-penny increments to erode the incentives of investors to display limit orders. The SEC designed the rule to limit the ability of market participants to gain execution priority over a competing limit order by “stepping ahead” by an economically insignificant amount.

Among other related concerns is the idea of uncertainty with respect to the NBB and NBO. So for a stock trading near the $10 range (with a NBB of 10.00 and a NBO of 10.02), if the financial systems (including those systems in place which allow trading of securities in the US and systems in foreign countries) would allow a buyer to place a bid higher than the NBB, but smaller than the next bidding increment (the next bidding increment would be 10.01 based on the 0.01 tick size), a buyer could place a higher bid on the stock, because he or she would be offering a price higher than best bid without offering to pay the full $0.01 more. This buyer might bid $10.001. Of course that $10.001 bid would only remain the new highest bid so long as a second buyer doesn't place a second incrementally higher bid than the first bid, such as $10.0001. If that happened, than the first bidder would have to incrementally raise his or her bid to remain at the NBB. Since the minimum increment a buyer could raise his bid would be infinitesimally small if restrictions on minimum tick size were released, the NBB and NBO might constantly experience micro price movements (requiring extra processing power to track and adding some uncertainty to the market.). Since a display of the current NBB and NBO technically cannot be instantly updated, an average value or time lapsed value of the NBB and NBO would need to be displayed. Such an outcome (called the “BBO Uncertainty Effect”) might not be advantageous to trading in the US or in foreign countries. As a result, most countries set a minimum tick size either for all securities or as a function of price of the stock.

FIG. 4A illustrates a buyer 50 and seller 60 interfacing with a server 10 hosting a trading platform 200 stored on tangible computer readable storage media 40 (CRM). The trading platform may be executed from tangible computer storage media 30 by a processor 20 such as a microprocessor, logic, or integrated circuit. The server may comprise other components such as a network interface, power supply, graphics card, and display. A buyer 50 interfaces with the server 10 through a client computer that has made a connection (internet, wifi, intranet) to the server.

FIG. 4B illustrates a buyer 50 and seller 60 interacting with the trading platform 200. The client can log into the trading platform 200 via a client interface 470. The trading platform server 10 may power a website or other trading program in which clients can interact. The website or program would be displayed on a client computer that a buyer or seller can interact. The matching engine 478 may be configured to receive bids and offers, arrange them in queues or books, match them as appropriate, and execute them as needed. The matching engine 478 may report market distribution data to the client interface 470 and the Securities Information Processor (SIP) 472 (that collects and consolidates data from market participants and distributes the consolidated information. The public view determination module 1300 may be configured to determine the BBO (Best Bid and Best Offer) each including a price per share and notional. This data may be output to both the SIP and client interface 471. The drop adaptor 48 may split data to the trade reporter 482, clearing module 484, and risk module 486. The trade reporter maintains a log of all executed trades, the clearing module 484 authorizes transactions, and the risk module 486 flags unusual trading patterns.

FIG. 4C shows a process flow diagram for orders 501 and executions 502. An order can be a bid to buy an instrument (such as a security) or an offer to sell an instrument. The trading platform server 10, which may store the trading platform on tangible computer readable storage media, may comprise instructions to perform one or more of the processes or instantiate one or more of the following modules shown in FIG. 4C. Match analyzer 488 may determine whether an incoming order 501 matches any preexisting orders in the offer notional book (e.g. a matching bid and offer). The matching analyzer 488 may mark the order for execution if there is a matching order (490). If there are any unfilled shares (meaning that the size of the order was larger than the existing size of matching orders) (492), the match analyzer can post the difference in the bid order book or offer order book (1101 or 1401) as appropriate, which may eventually be posted (494) after processing by the bid and offer analyzer 505 into the bid notional book 1201 or offer notional book 1501 (FIG. 5B). (If there are no shares left 496, the process may end.) A single execution or cancellation of an order may affect the BO or BB, so to recalculate what the BBO should be, the bid and offer analyzer may check (512) all the orders in the bid and offer notional books to see if any are higher than the BBO by walking through the orders in the book 510 (if the notional book is sorted, this check may simply require checking the BBO versus the top of book.) Once there are no more orders to check, the process will end (521). While the process is running, the bid and offer analyzer 505 may check whether a currently selected offer is greater than the BBO (515). If not, the next order can be checked (523) (this might not be necessary in a sorted book, since the next bid should theoretically be lower, making the extra check not needed.) If the resting order (order in the notional book) is >=to the BB (or <=BO), the bid and offer analyzer can determine a cumulative notional value using the formula CN=CN (order price×order shares), meaning that the analyzer 505 will keeping a running total of the notional values of orders that were analyzed beforehand (518). If the cumulative notional value exceeds the notional constraint (520), the bid can be sent to the public view determine module 1300 to be published as the best offer or best bid 525.

Bid and offer analyzer 505 may be configured to determine whether the current bid or current offer changes the BB or BO, place the bid or offer into the notional book, and determine whether a group of bids has a sufficient cumulative notional to meet the notional constraint. The public view determination module 1300 can post any changes in BBO after updating the bid notional book. If there are no shares left (492), the process may end (496), and the platform may be configured to wait for new bids or offers.

FIG. 5A illustrates a trading platform 200 configured to allow buyers and sellers to place bids and offers in increments smaller than the tick size, and have those bids or offers fulfilled provided certain requirements are met (so for example a bid of 10.015 and 10.002 would be permitted). In FIG. 5A, a buyer can place a new bid 201, or a seller can place a new offer 202 at the trading platform 200. A bid receiver 211 can receive a new bid and an offer receiver 212 can receive the offer. Both the bid receiver and the offer receiver can utilize a notional value calculator 220 to determine the notional value of the bid or offer. Notional value equaling number of shares times price per share.

The trading platform 200 can also determine or receive the national best bid (NBB) 231 and national best offer (NBO) 232 which may be calculated directly or obtained from a data provider (such as SIP). The data can be obtained by an NBB 233 and NBO module 234, and used to determine a tick size by a tick size determination module. NBO-NBB=tick size. Alternatively the tick size could be output to the trading platform directly by a data source.

The platform 200 may be configured to check if there is a matching offer upon receipt of a bid (before even checking whether bid satisfies the notional constraint). The trade match module 213 can check if there is an offer that matches the bid, and if so, the platform 200 can execute the trade 214 (or have it executed by another platform.) If there is no immediate match, the trading platform 200 can send the bid to the bid processor 261 to be processed into the bid order book (1101, FIG. 5B). The same is true for an offer, the offer processor 262 can process the offer, placing into the offer order book 1401. The trading platform 200 may also comprise a notional constraint 250 which may be a value input directly from a data source, or the value may be determined via feedback loop. The minimum threshold could be set to X basis points of the average daily notional.

X may be set by the industry to a value the industry considers economically relevant. Below are examples based off of a 1 bps (basis point) (0.0001) notional constraint or minimum threshold: Stock A's average daily notional traded is $11.5 billion. 1 Bps of $11.5 B is $1,155,000. So the notional threshold for stock A would be $1,155.000. If stock A is trading at $550, the platform would require 2,100 shares to trip the minimum threshold. Stock B's average daily notional traded is $238 million. 1 bps of $238 million is $23,800. So the notional threshold is $23,800. If stock B is trading at $25, the platform may be configured to require 950 shares to trip the minimum threshold. The notional constraint 250 may use a minimum notional trading amount in order to place bids above the NBB (usually finer than the $0.01 minimum tick increment currently in place) and offers below the NBO (usually finer than the $0.01 minimum tick increment).

FIG. 5B shows a process flow of bids placed into the bid order book 1110 or offers placed in the offer order book 1401. Each book has an organizer for inserting the bid into a book based on the bid value and time of bid. The organizer may sort the bids in the book by price or time of entry. The bid and offer organizers (1100 and 1400) may also determine bid groupings and deliver bid grouping information to the bid notional book 1201 and offer notional book 1501. The bid notional book organizer 1200 and offer notional book organizer 1500 can re-group bids pricing if an offer or bid is executed or canceled. The public view determination module 1300 determines the best bid 1302 and best offer 1312 for display to the public. The determination module 1300 may also send the BB/BO to the SIP for reporting A best bid may have a price per share 1304 and a notional value 1306, and a best offer may have a price per share 1314 and a notional 1316. As shown, a best bid determination module 1350 and best offer determination module 1360 may be used to determine the best bid and best offer respectively. In some configurations, modules 1350 and 1360 will check the top of the bid notional book and offer notional book respectively to determine the bids and offers comprising the best bid and best offer. As shown next in FIGS. 6 and 7, modules 1350 and 1360 may check newly received bids and offers received by the trading platform to determine whether they are equal to the current best bid or best offer. In such a case, the trading platform may be configured to bypass adding the offer or bid before adding the offer or bid to the offer notional book or bid notional book. This configuration may help increase the speed in which aggressive offers or bids are executed.

FIGS. 6 and 7 are detailed views of the bid processor and offer processor. A bid for a particular security may be less, equal to, or greater than the best bid (BB), and the amount in which a bid is less or greater than the BB may be a multiple of the tick size or not (some configurations do not have a tick size). If the bid is equal to the BB (311), the bid processor 261 may send the bid to bid notional book 1201 via a bid placer 350. Alternatively, the bid may be sent directly to the best bid module since the processor may not need to determine a price band for the bid, because the bid is at the best bid price. If the bid is greater than the BB, but the amount greater than the BB (the surplus) is a multiple of the tick (known as a limit order), the bid placer will send the bid to the bid notional book 1201 (322). If the bid is less than the BB, but the amount less than the BB (the deficit) is a multiple of the tick, the bid will be sent to bid order book 1201 (323). Some configurations may not use a tick at all. For example, all bids may be stored (by bid storer 341 for example) into a bid order book 1101, and sorted into bid groups by the bid price regardless as to whether the bid price is a multiple of current $0.01 MPV or not. In such a configuration processes 322 and 323 would be removed. A bid decider 360 may use one or more multiple rules to determine which bid should be placed in front of a best book for a particular bid group. Since a bid group may comprise multiple bids, and bids may be placed for differing notionals, prices, and at different times, the bid decider can use a priority algorithm to determine which bid from the best bid book to execute first. For example, the bid decider 360 may place the bid that was placed first in time (e.g. to encourage early bidding) (361). Or, the bid decider may select to place the highest bid (362). Or, the bid placer may place the bid having the largest notional value (to reward the bidder placing the bid with the largest notional value) (363). Or, the bid placer may place the latest bid on top, which would usually be the bid needed to overcome the notional constraint (364). Or, a pro rata selection of the bids in the bid group may be selected. The bid order book organizer 1100 may be configured to determine bid groupings for bids in the bid order book 1101, so that they may be placed into the bid notional book 1201. As shown, a bid equal to the best bid may bypass the bid placer and be added to the best bid notional directly, since there is no need to verify the notional value is sufficient for that bid. Moreover, directly placing the bid into the best bid book may allow the offer to be executed more quickly.

FIG. 7 shows the offer processor 262 in additional detail. If the offer is equal to the BO (411), the offer processor 262 may place the offer into the notional book 1501 via an offer placer 450. If the offer is less than the BO, but the amount less than the BO (the surplus) is a multiple of the tick, the offer will be placed (422) into the notional book and will be the new best offer. If the offer is greater than the BO, but the amount greater than the BB (the deficit) is a multiple of the tick, the offer will be placed (423) into the offer notional book 1501, but it won't be the best offer. If none of these three conditions are true, and thus the offer does not equal (!=) the BO and the surplus or deficit is not a multiple of the tick size, the offer processor 262 may place the offer if the notional value is greater than notional constraint 250 (430). (As in the bid processor, embodiments not using a tick at all are possible, eliminating steps 422 and 423.) The offer decider 460 may use one or more rules to determine which offer from the set of unplaced offers to place. For example, the offer decider 460 may place the offer that was placed first in time (e.g. to encourage early offering (461)). Or, the offer decider may be configured to select the lower price offer (to encourage offering below the NBO) (462). Or, the offer decider may place the offer having the largest notional value (to reward the offerer placing the offer with the largest notional value) (463). Or, the offer decider may select the latest offer proposed (464). The offer order organizer 1400 can determine offer groupings for offers in the offer order book 1401, so that they may be placed into the bid notional book 1501.

FIGS. 8A and 8B are process flows diagrams. FIG. 8A shows what happens when a bid is received 801 by the bid platform 200. The platform determines (by the offer matcher 1052) whether the bid is greater than or equal to the lowest offer to sell 803. If so, the trade is executed 805 (by the bid executor 808). Otherwise the bid is sent to bid processor 261, so that it may be placed in the bid order book 1101. If the trade is executed, the offer notional book organizer 1400 may be called to regroup offers in the offer notional book 1401. In FIG. 8B, the platform receives an offer 802, and determines (via bid matcher 1051) whether that offer is less than or equal to the high bid in the bid notional book (the best bid) (process 804). If so, the trade is executed (by offer executor 809), and the bid notional book organizer 1100 can regroup bids in the bid notional book organizer 1101. If not, the offer processor 262 can process the offer, and place it in the offer order book 1401.

FIG. 9A shows another process flow diagram of the trading platform, particularly how received bids 802 and received offers 804 are handled. Once the trading platform receives a bid 802, the best bid module 1350 may be configured to determine (before even considering whether constraint notional is met), whether there is an existing offer in the best offer book 1312 (the same could be done for a new offer in which a comparison is made against the best bid book 1302) which matches the bid 910 (generally this would be the best offer). Processes 1033A and B may be used to match the bid or offer with the highest bid or offer in the book. If so, an order executor 807 may execute the trade 1011. The matching engine may also updates it's book (927) by informing the bid order book organizer 1100 or the offer order book organizer 1400 of the trade.) The order executor 807 (which may comprise an individual bid executor 808 and offer executor 809 see FIGS. 8A and 8B) may also inform the bid order book organizer 1100 and/or bid notional book organizer 1200 to remove the bid from their respective books (offer order book organizer 1400 and offer notional book organizer 1500 may be similarly informed). Similarly, in the event a bid is cancelled (e.g. expires, user cancels the bid, etc.), an order canceller 907 (which may also comprise an individual bid canceller 908 and offer canceller 909) may also inform 911 the bid order book organizer 1100 and/or bid notional book organizer 1200 to remove the bid from their respective books. (Naturally, if an offer is cancelled, the order canceller would inform the offer order book organizer 1400 and/or offer notional book organizer 1400 to update their respective books.) If there are no matching offers to execute, the best bid module may send the bid to the bid order book organizer (process 914A). The bid order book organizer 1100 may determine (917A) a slot position in the bid order book, and insert (920A) the bid. (Alternatively or in addition, the new bid could simply be added to the book, and then the book can be sorted.) Once the ordered book is generated, the book may be sent (923A) to the bid notional book organizer 1200. The bid notional book organizer may determine bid groups in bid notional book (process 925A). The best bid module may determine a collapsed best bid (adding the notional values of the group having the highest price together), and send that value to the public view determination module 1300 so that it may be reported to the SIP and displayed as a best bid for the platform (1032 and 1031). (FIG. 9B, illustrates how the platform sends an offer to the offer book organizer 914B, shown on a separate figure because of space limitations. Processes, 917B, 920B, 923B, and 925B perform similar functions as their bid counterparts mutatis mutandis.)

The best bid module may save the best bid in a best bid book 1302 that the matching engine 478 can reference if it receives a new market offer 804 (or any other offer.) The best offer module may save the best offer in a best offer book 1312 that the matching engine 478 can reference if it receives a new market bid 804. Assuming a market offer is received, the matching engine 478 can determine the group having the best bid, and order executor can determine which bid in the best bid book to execute. The order executor could use a bid decider 360A (or offer decider 360B) comprising a rule engine to assign priority as to which bids to select to pair with the offer. For example, the bids having the highest original price in the bid group could be selected, the bids placed earlier in time could be preferred, or order placed later in time could be preferred. The bid decider could award priority based on notional size, or offer priority to the bid needed to fulfill the notional value constraint. In some configurations, the bids will be executed pro rata, meaning that all bids in the bid group will have an equal number of shares executed on for each matching offer. The bid executor may also inform the bid order book organizer 1100 and order bid notional book organizer 1200 to update their respective books after the trade is executed.

FIGS. 10A and 10B shows a graph. FIG. 10B shows the same graph as 10A except the line “raw: triangle” is removed to reduce cluttering of the graph. Referring to FIG. 10A, the graph on the left shows the X axis bid prices. The graph on the right shows the X-axis ask prices. The Y Axis is notional value. The line with triangles (2205) at vertices (bids & asks) represent raw market data from an exemplary security at time t. The market-data is aggregated by price level. The triangle lines show how much notional is at each price level, as price levels move away from the inside. The lines with the triangles in the mid-point of the underlying market data. The lines with squares, and the lines with circles illustrate the dynamic tick process on the same market data. The vertical line on the right is the mid-point of the displayed prices after “dynamic tick” processing. The lines with the squares shows in round notional units. For example, assume 5K notional as the dynamic tick unit, and you only display prices levels that are an even multiple of 5K. The lines with the circles illustrate a price point that has 5K or above, and show the size in notional value. The graph represents both the change in the number of price levels, and the liquidity at each price level by each method of the “dynamic tick” process. The graph shows that the “min-notional” or “square” line process yielded better results.

FIG. 11 shows some of the possible functions of the bid order book organizer 1100. Upon calling the organizer, the organizer may sort the bids by price 1150. Some configurations of the bid order book organizer may form the bids into groups (1152) based on the price and notional and transfer (1154) this group information to the bid notional book organizer (1200, FIG. 12), but other configurations of the bid order book organizer do not have this functionality. Whether it is the organizer 1100 or 1200 (or offer order book organizer 1300 or offer notional book organizer 1400) performing the grouping, the number of bids (or offers) in the group will depend on the notional value of each bid (or offer), the organizer requiring the members of the group to have a cumulative notional value above the notional constraint. To actually generate the bid group information (form the bids into groups), the bid order book organizer 1100 (or the bid notional book organizer 1200 as the case may be) may select the bids at the highest price 1156, and sum the notional value of the bids 1158. If the sum of notional value is greater than or equal to the constraint 1160, the bids are placed into a first group 1162, and the bid order book organizer 1100 checks the bids at the next highest price to see if their aggregate notional value meets the notional constraint to form a second bid group 1163. For all bids in a price band that do not have enough notional to satisfy the notional constraint, the organizer 1100 will select the bids in the next lower price band and group them with the previous band (1164). The organizer 1100 will then determine whether the sum of the notional of the current band and the next lower band is greater than the constraint (1166). If so, those bids in those two price bands are formed into a bid group (1172). If not, the bids in the next lower price band (nth band) are added with the bids in the first and second band (1170). The process repeats (1174) until enough bids are collected to satisfy the notional constraint (e.g. go back to step 1166), or the organizer runs out of bids to collect. If the latter, the organizer can either not place those bids at all into the bid notional book, or place them at a price point equal the lowest bid group the bids into groups by price (1176).

FIG. 12 illustrates a process flow for the bid notional bid organizer 1200 that occurs after the order executor 807 (FIG. 8) informs the bid notional book organizer 1200 that a bid has been executed (or the order canceller cancels a bid). The notional organizer 1200 may be called by the order executor 807 (or the order organizer 1100 in some configurations) after a bid from the bid notional book is executed. The organizer 1200 may modify bid grouping of the bid notional book based on the change in bids present in the bid notional book 1201 (FIG. 5B). The organizer 1200 may check to see if the bids are sticky (1202), meaning whether or not bid groups change after a trade is executed. If so, no regrouping is needed, and the process ends (1204). If not sticky, the bid notional book organizer may check if the bids in the first bid group still have a high enough cumulative notional value to satisfy the notional constraint (1206). In some configurations, a semi-sticky embodiment may be employed where a lower constraint is needed to maintain price grouping (e.g. half the notional constraint) before the organizer 1200 will regroup the bids. If the notional constraint is no longer met by the bid group, the organizer 1200 will select the bids in the next highest price band (1208). The organizer may be configured to determine whether the notional value of the first bid group and first price band outside the bid group (recall bands are bids at a particular price, and a bid group can contain bids from one or more price bands) are greater than the notional constraint (1210) (or some reduced notional constraint in a semi sticky configuration.) If not, the process will repeat, for the second, third, fourth, nth band until the notional constraint is satisfied (1212). Once enough bids are grouped together, the organizer 1200 sets the price for that group equal to the lowest price in the bid group 1214. If there are no more bids in the bid book 1204B, the process ends 1204A. Next the organizer repeats the previous steps for the next bid group 1216. If next highest bid group satisfies the notional constraint, the process ends 1218. If not, the organizer selects the bids in the next high price band, adds their combined notional value to the current bid group, and checks if the combined notional value satisfies the notional constraint 1220. The process repeats 1222, until enough bids are collected so that they satisfy the notional constraint. The group price is set to the lowest price in the bid group 1224. Then the organizer can check if there are any unchecked bid groups still left in the book (1226), if so, it repeats step 1216 for the next lower bid group. Once a bid group is checked and doesn't need regrouping because the notional constraint is met, it is not necessary to check lower bid groups since those grouping should change (unless bids are cancelled or expire for example.)

FIG. 13 illustrates an exemplary bid order book 1101 and a bid notional book 1301. The bid order book organizer 1100 forms bid groupings of orders A-J (order I is cancelled in this example.) Bids F, G, & H are grouped together as the best bid by the public view determination module 1300, and may display the best bid, price per share $10 (1312), and notional of $700 (1314) to audiences. In this example, it is order F that is on top of book because order F was placed before order G. FIG. 14 illustrates a process flow wherein the more aggressive priced bid is on top of book.

FIGS. 15 and 16 illustrate the effect that a first and second market order has on the bid notional book. In FIG. 15, order G is executed at $10 a share, causing the bid notional book organizer 1200 to regroup the bids. For example, orders F and H are grouped with orders A, B, E. The public view determination module 1300 would collapse orders F, H, A, B, and E together into a single best bid of $9 at notional $900. FIG. 16 shows order F being executed at $9/share.

FIGS. 17 and 18 show a semi-sticky order type wherein the constraint to meet after an execution is only $350 (down from $700). FIGS. 19 and 20 illustrate the process flow for a sticky order, wherein the prices of the bids do not change after execution of an order.

FIGS. 21A-21B show an exemplary process flow of the bid order book organizer 1100 adding new bids to bid order book 1101. Orders A-I (in Table A) are ordered sequentially, and the constraint is $5000 as shown. FIGS. 21A-21B feature a configuration that does not have a default or minimum tick. The bid and offer analyzer 505 (referring now to FIG. 21C) can receive an offer, and check if it is less than the best offer. In this example, since the offer is a market offer, the order will be executed against the best bid(s). Otherwise, if the offer were for more the best bid, then offer would be placed (2110) in the offer order book (and possibly in the offer notional book.) The matching engine 478 can determine from the bid order book 1101, which bids to select. The matching engine 478 can have a number of additional constraints such as whether time or bid has priority. If the orders are assigned identifiers such as shown, and the identifiers are created in numeric order, a single table could illustrate both the timing and the price priority. In this example, the matching engine 478 is configured to give priority to price, and there is no requirement for all or non lots (in this example). As shown, the matching engine 478 selects bids, E, C, and part of bid B. These bids are placed in an order execution book 2101, wherein an order executor will execute the orders. A bid remover 2200 can determine the bids to remove 2201 from the bid order book 1101. The bid order book organizer 1100 can pass the new list of bids to the bid notional book organizer 1200 which can form new groupings of the bids in the bid notional book. In this example orders B+G, D+H, and A+F each satisfy the notional as a pair, so no change in the bids occurs. But if the notional for H were 4000 instead of 4500 (and the bid notional book organizer 1200 were employing a non-sticky bid order type), the bid price for D and H would drop to $10.00, and A would raise to $10.00, and bid F would be removed.

As shown in FIG. 21D, the bid order book and bid notional book are shown as separate queues in FIG. 21C, but the queues could be combined and redundant sections eliminated to form a bid actual and adjust book 2301. Likewise the functionality of the bid notional book organizer and bid book organizer could be combined into a single bid actual and adjust book organizer 2300. Similar modifications for the offer order book and offer notional book could be made as well.

### Example 1

So for example: in US equities, the average trade size is around 250 shares. Given the average stock price is around $25.00, this means the average notional traded is $6,250.00. As an example, a metric for good price formation for a US equity may be $20,000.00 on both the bid and ask. Market participants may place orders at any arbitrary price level, but the exchange only shows price levels where the notional value of the aggregated orders reaches $20K of value. Meaning that the market participants (buyers and seller) only see price levels if the size at each price level is equal to at least $20K notional (combined). In other words, the platform will only make public groups of bids that have a combined notional value greater than $20K. In some configurations, only the bid on top of the book (the best bid) is made publically available. This can also be thought of as changing the round-lot size from shares to notional value. Or, alternatively it can be thought of as aggregating an order by notional value, instead of price levels.

The trading platform may be of use to small and mid-sized stocks as exchange price formation is not as efficient as for Large Market-Cap stocks. For example, the order book in stock on the Nasdaq stock market at time. This is based on the order information that Nasdaq disseminates. The “units” are how many multiples of $20,000.00 exist at each price level.

The spread between the best buy price and the best offer price is larger using the Dynamic Tick Size. This relationship shows that there is more risk trading this low-volume stock. The ideal tick size should be wider.

Prices levels are roughly {xyz} apart. This would suggest that the appropriate tick size for this symbol is {xyz} according to the participants in the market at this time.

### Example 2

Assuming a notional of 50K and the minimum increment to 0.0001.

### Example 2

### Scenario 1

1. Trading platform determines the NBBO (National Best Bid and Offer) to be $10.00 (Bid) and $10.01 (Offer) for security X.

2. The trading platform receives an order, Order #1, from trader A, to buy 2,500 shares @ $10.001/share at time T₁. The notional being $25,002.50.

3. The trading platform does not adjust the BB, because changing the BB requires an aggregated notional of $50,000. As a result, the order is not filled even though the offer of $10.001 is less than the best offer of $10.01.

4. The trading platform receives a bid to sell 100 shares of security X for $10.00/share at time T₂. The trading platform fills the order at $10.00 and not $10.001 because the notional constraint was not met.

### Example 2

### Scenario 2

1. Trading platform determines the NBBO (National Best Bid and Offer) to be $10.00 (Bid) and $10.01 (Offer) for security X.

2. The trading platform receives an order, Order #1, from trader A, to buy 2,500 shares @ $10.001/share at time T₁. The notional being $25,002.50.

3. The trading platform does not adjust the BB, because changing the BB requires an aggregated notional of $50,000. As a result, the order is not filled even though the offer of $10.001 is less than the best offer of $10.01.

4. The trading platform receives an order, Order #2, from trader B, to buy 2,500 shares of security X @ $10.002/share at time T₁. The notional being $25,005.00.

5. The trading platform changes the national best offer to be $10.001/share, the national best bid remains at $10.00/share.

6. In one configuration, the trading platform fills trader A's order to buy 2500 @ 10.001. In this configuration, the platform is configured to execute the order from the trader that placed the order first in time. In a second configuration, the trading platform fills trader B's order to buy 2500 shares, because trader B offered a higher price to buy the shares than trader A.

7. The trading platform receives at time T₃ a bid to sell 100 shares of security X @ $10.00/share from trader C.

8. The trading platform changes the national best offer back to 10.00 because the notional fell below 50K after the platform filled trader A's order (in the first configuration).

VWAP pricing (variable weight average price (the ration of the value traded to total volume traded over a particular time horizon such as a day, and “min pricing” (the price of an order that first crosses X-VWAP on the book). A “max price” provides an incentive to traders to place small orders in front of the quoted price, in the hopes it won't trip to a new price level. It also quotes less.

VWAP price publishes a new quote for every order, and it's really easy to tell if someone is “leaning” on you, and by how much. Configuring the platform to quote a maxp price, and executing at VWAP would be cool, but it would mean disimproving orders on the book. And I haven't convinced myself that it can't be gamed.

Configuring the trading platform to publish and execute at VWAP may cause the platform to “leak” information. Executing—having the platform fulfil orders—at VWAP means price dis-improvement. Such a configuration may be undesirable in markets where traders disfavour having their disimproved. Moreover, some traders may disfavour having their limit price violated. Executing order at VWAP can cause limit orders to be violated. To avoid this outcome, the platform may be configured to fulfil the highest bid or lowest offer that satisfies the minimum notional requirement. Alternatively, configuring the platform to fulfil bids or offers placed first in time (“fifocation”) for orders only that turn the market (the additional bid or offer needed to satisfy the notional constraint) and pro-rata allocation to all others is an additional configuration. In this configuration, orders from traders that essentially “tip the scales” (exceed the minimum aggregation of notional) are given priority over orders that do not tip the scales. In example 1, scenario 2, trader B tips the scales, so in a fifiocation configuration, the platform would fill trader's B's order, but not trader A.

A FiFo (first in, first out) configuration will probably create a “stickier” order. Stickier orders may be advantageous for the operator of the financial platform because allowing traders to effectively change the BBO on a near continuous basis (every time a new order is placed), would create BBO pricing that may adjust every split second. In other words, while configuring the trading platform to adjust the BBO to dynamically set the min tick size based on the market orders may be enhanced, constantly changing the min tick size. Thus having a threshold notional value for orders of a given security creates a stickier pricing structure slowing down the movement of the NBBO. Also, it is just one less new variable as compared to the typical cash equivalent market structure (which is the asset class-product type combo that I assume we will try to apply this to first). Creating a financial platform that is configured to dynamically set the min tick is beneficial.

### Example 3

Assume a security in the IFXD (one of the European stock exchanges) has a price such that it trades in 1/10ths (meaning the tick size is $0.1/share or 0.1 (generic currency units/share). The security's notional book has lots of gaps in price levels, e.g. the difference between priceband n and priceband n−1. In many ways the trading history of this exemplary security resembles a US stock trading history, which is common for German stocks. Both the VWAP and BID-MAX/ASK-MN for 20K notional may be used. The data is from equiduct's web-site (very cool for looking at books BTW). The MIX/MAX inside is much wider than would be predicted.

What is claimed is:

1. A server comprising a processor and tangible computer readable storage media, the storage media comprising instructions for the processor to execute a trading platform comprising:
a. a notional constraint used by a bid notional book organizer to separate bids into one or more bid groups;
b. a bid receiver configured to receive a plurality of bids to purchase shares of a security at a bid price, each bid having a notional value;
c. a bid order book organizer configured to maintain bids in a bid order book in price order;
d. a bid notional book organizer configured to create a first group of bids from the plurality of bids by:
i. selecting from the plurality of bids, a first bid having a highest price;
ii. storing the first bid into the bid notional book as first group if the first bid has a notional value greater than the notional constraint,
iii. if not, selecting from the plurality of bids, a second bid having a next highest price and determining whether a cumulative notional value of the first and second bid is greater than the notional constraint, and storing the first and second bid as a first group if the first bid and second bid have a cumulative has a notional value greater than the notional constraint;
iv. if not, selecting from the plurality of bids, n bids and determining whether a cumulative notional value of the n bids is greater than the notional constraint, and storing the n bids as a first group, if the n bids have a cumulative notional value greater than a notional constraint; wherein n is an integer greater than 2.

2. The trading platform of claim 1, comprising a match analyzer configured to:
a. send a bid having a price greater than or equal to the best offer to a bid executor configured to execute the bid against the best offer; and
b. send a bid having a price less than the best offer to a bid order book.

3. The trading platform of claim 1, wherein the bid order book organizer is configured to maintain the bid order book by sorting the book by price, or inserting the bid into the book such that the resulting book is in price order without sorting.

4. The trading platform of claim 1, wherein the bid notional book organizer is configured to receive a plurality of bids from the bid order book in price order.

5. The trading platform of claim 1, wherein the bid notional book organizer is configured to create a second group of bids from the plurality of bids by:
a. selecting from the plurality of bids, a first highest bid not in the first bid group and determining whether the notional value of the first highest bid is greater than the notional constraint, and storing the first highest bid into the bid notional book as a second group if the first highest bid has a notional value greater than a notional constraint;
b. if not, selecting from the plurality of bids, a second highest bid not in the first bid group and determining whether a cumulative notional value of the first and second highest bid is greater than the notional constraint, and storing the first and second bid into the bid notional book as a second group if the first and second highest bid have a cumulative notional value greater than a notional constraint;
c. if not, selecting from the plurality of bids, n bids having highest bids not in the first group and determining whether the cumulative notional value of the n bids is greater than the notional constraint, and storing the n bids as a second group, if the n bids have a cumulative notional value greater than the notional constraint.

6. The trading platform of claim 1, wherein the bid notional book organizer is configured to determine the bid having a lowest price in the first group of bids, and set a first group bid price for the first group equal to the lowest price.

7. The trading platform of claim 6, wherein the bid notional book organizer is configured to determine the bid having a lowest price in the second group, and setting a second group bid price for the second group equal to the lowest price.

8. The trading platform of claim 6, wherein the bid notional book organizer is configured to set a best bid equal to the first group bid price.

9. A server comprising a processor and tangible computer readable storage media, the storage media comprising instructions for the processor to execute a trading platform comprising:
a. a notional constraint;
b. a bid order book;
c. a best bid module for receiving a best bid;
d. a best offer module for receiving a best offer;
e. a bid receiver for receiving a plurality of bids to purchase shares of a security at a bid price, each bid having a notional value;
f. a bid processor configured to determine whether there is an outstanding offer that is less than or equal to the bid;
g. a bid placer configured to place the bid into the bid order book;
h. a bid storer configured to store the bid as an unplaced bid in the bid order book, if the bid is not placed; and
i. the bid processor configured to place at least one of the unplaced bids into the bid notional book, if an aggregate of the notional values of the unplaced bids in the data store has an aggregated notional value greater than or equal to the notional constraint, else not placing any of the unplaced bids.

10. The trading platform of claim 9, wherein the bid processor is configured to store any bids which are not placed in the bid notional book into the bid order book.

11. The trading platform of claim 9, comprising a bid decider configured to award priority to at least one of the bids stored in the bid order book.

12. The trading platform of claim 9, comprising:
a. a tick size module for determining or receiving a tick size; and
b. wherein the bid placer is further configured to:
i. place the bid into the bid order book if the bid price is equal to the best bid plus an additional amount, wherein the additional amount is equal to a multiple of the tick size;
ii. place the bid if the bid price is equal to the national best bid plus an additional amount, wherein the additional amount is less than the tick size, but the notional value of the bid is greater than the notional constraint.

13. The trading platform of claim 11, wherein at least two of the received bids are received at different times; and the bid decider is configured to award priority to the bid received first in time.

14. The trading platform of claim 11, wherein at least two of the received bids are received at different times; and the bid decider is configured to award priority to the bid proposed last in time.

15. The trading platform of claim 11, wherein at least two of the received bids have different associated prices, and the bid decider is configured to award priority to the bid received with a higher price.

16. The trading platform of claim 11, wherein: at least two of the received bids have different notional values; and the bid decider is configured to award priority to the bid having a higher notional value.

17. The trading platform of claim 11, wherein:
a. a first, second, and third bid are received, wherein a sum of the notional values of the first and second bid are less than the notional constraint, but a sum of the notational values of all three bids is greater than or equal to the notional constraint; and
b. the bid decider is configured to select the third bid.

18. The trading platform of claim 11, comprising an offer receiver for receiving a plurality of offers to sell shares of a security at an offered price, each offer having a notional value.

19. The trading platform of claim 18, wherein the bid processor is configured to:
a. place a received offer, if the price offered is equal to the national best offer;
b. place at least one of the received offers into the bid notional book, if at least one offer has a price less than the best offer into the bid notional book, and an aggregate of the notional values of the offers has a price greater than or equal to the notional constraint;
c. else the bid processor will not place a received offer into the bid notional book.
